(19) United States
(12) Patent Application Publication
(10) Pub. No.: US 2026/0170523 A1
(43) Pub. Date: Jun. 18, 2026

(54) DETERMINATION OF ACCESSIBILITY OF USAGE OF VEHICLES IN A GEOGRAPHICAL REGION

(71) Applicant: HERE GLOBAL B.V., EINDHOVEN (NL)

(72) Inventors: JEROME BEAUREPAIRE, NANTES (FR); JEREMY MICHAEL YOUNG, BEVERLY HILLS, MI (US)

(73) Assignee: HERE GLOBAL B.V., EINDHOVEN (NL)

(21) Appl. No.: 18/985,079

(22) Filed: Dec. 18, 2024

(51) Int. Cl. G06Q 30/0204; G01C 21/34

(52) U.S. Cl. CPC G06Q 30/0205; G01C 21/3461; G01C 21/3469

(57) ABSTRACT

A system for determination of accessibility of a usage of vehicles in a geographical region is provided. The system obtains a first set of parameters associated with a consumption of a battery by a set of vehicles in a first geographical region. The system further obtains a second set of parameters associated with at least one of the set of vehicles or a set of charging points within the first geographical region. The system further determines a first index based on the obtained first set of parameters. The system further determines a second index based on the obtained second set of parameters. The system further determines a first accessibility score based on the first index and the second index. The first accessibility score is indicative of an accessibility of a usage of the set of vehicles in the first geographical region. The system further outputs the determined first accessibility score.

### TECHNOLOGICAL FIELD

The present disclosure generally relates to determining the accessibility of usage of vehicles in a geographical region, and more specifically relates to a system and a method for determination of accessibility of usage of vehicles in the geographical region.

### BACKGROUND

With advancements in the field of automobile engineering, electric vehicles (EVs) have gained popularity as an alternative to conventional internal combustion engine (ICE) vehicles. The EVs are automobiles powered primarily or entirely by electrical energy. Specifically, the EVs are propelled using electric motors that convert electrical energy into mechanical energy. The utilization of EVs in transportation is advantageous as compared to conventional ICE vehicles. Such advantages include, but are not limited to, reduced carbon emissions, high energy efficiency, low operating cost, and improved performance.

However, various factors associated with a geographical region can decrease the accessibility of usage of EVs in the geographical region. For example, driving EVs in a geographical region with high slopes consumes more energy than driving in the geographical region that has a flat terrain. Additionally, weather conditions associated with the geographical region can impact the performance of the EVs. For example, extreme temperatures, whether hot or cold, significantly impact the performance and efficiency of the battery of the EVs. In cold weather, the batteries of the EVs may experience decreased efficiency and capacity, leading to a reduced driving range, while in hot weather, excessive heat may accelerate the degradation of the battery of the EVs. Moreover, the accessibility of charging stations in the geographical region may be limited due to various real-time factors associated with the geographical region such as high demand during peak hours, charging station maintenance, limited parking space, traffic, and the like.

Therefore, there is a need to determine the accessibility of the usage of EVs in the geographical region to overcome the aforementioned challenges associated with the accessibility of EVs usage in the geographical region.

### BRIEF SUMMARY OF SOME EXAMPLE EMBODIMENTS

A system, a method, and a computer programmable product are provided for the determination of the accessibility of the usage of vehicles in a geographical region.

In one aspect, a system for determination of an accessibility of a usage of vehicles in a geographical region is disclosed. The system includes a memory to store computer-executable instructions and one or more processors coupled to the memory, the one or more processors are configured to obtain a first set of parameters associated with a consumption of a battery by a set of vehicles in a first geographical region. The one or more processors are further configured to obtain a second set of parameters associated with at least one of the set of vehicles or a set of charging points within the first geographical region. The one or more processors are further configured to determine a first index based on the obtained first set of parameters. The first index is indicative of the consumption of the battery by the set of vehicles in the first geographical region. The one or more processors are further configured to determine a second index based on the obtained second set of parameters. The second index is indicative of the utilization of at least one of the set of vehicles or the set of charging points within the first geographical region. The one or more processors are further configured to determine a first accessibility score based on the first index and the second index. The first accessibility score is indicative of the accessibility of a usage of the set of vehicles in the first geographical region. The one or more processors are further configured to output the determined first accessibility score.

In additional system embodiments, the first set of parameters includes at least one of vehicle parameters associated with each vehicle of the set of vehicles, or geographical region parameters associated with the first geographical region.

In additional system embodiments, the vehicle parameters are associated with at least one of a weight of each vehicle of the set of vehicles, a speed of each vehicle of the set of vehicles, a tire-size of each vehicle of the set of vehicles, an aerodynamic drag of each vehicle of the set of vehicles, an idling state of each vehicle of the set of vehicles, a battery size of each vehicle of the set of vehicles, a battery capacity of each vehicle of the set of vehicles, or a battery consumption rate of each vehicle of the set of vehicles.

In additional system embodiments, the second set of parameters is associated with at least one of mobility patterns of a user of each vehicle of the set of vehicles, a destination of each vehicle of the set of vehicles, a distance of each charging point of the set of charging points from each vehicle of the set of vehicles, an availability of each charging point of the set of charging points, or an infrastructure of the first geographical region.

In additional system embodiments, the one or more processors are further configured to receive a first user input associated with a destination of a first vehicle of the set of vehicles. The destination of the first vehicle is in the first geographical region. The one or more processors are further configured to determine the first accessibility score for the first geographical region based on the first user input. The one or more processors are further configured to determine a recommendation based on the first accessibility score and further output the determined recommendation.

In additional system embodiments, the one or more processors are further configured to generate one or more navigation instructions to navigate the first vehicle toward the destination based on the determined recommendation. The one or more processors are further configured to control the first vehicle to navigate toward the destination based on the one or more navigation instructions.

In additional system embodiments, the one or more processors are further configured to determine a consumption score based on a first correlation of the first index with a consumption factor. The one or more processors are further configured to determine a utilization score based on a second correlation of the second index with a utilization factor. The one or more processors are further configured to determine the first accessibility score based on a third correlation of the consumption score with the utilization score.

In additional system embodiments, the one or more processors are further configured to obtain a set of tiles associated with the first geographical region using a map database. Each tile of the set of tiles is indicative of at least one portion of the first geographical region. The one or more processors are further configured to determine a first set of indexes based on the first set of parameters for the corresponding tile of the set of tiles. The first set of indexes is indicative of the consumption of the battery by the set of vehicles in each tile of the set of tiles. The one or more processors are further configured to determine a second set of indexes based on the second set of parameters for the corresponding tile of the set of tiles. The second set of indexes is indicative of the utilization of at least one of the set of vehicles or the set of charging points in each tile of the set of tiles. The one or more processors are further configured to determine a set of accessibility scores based on the first set of indexes and the second set of indexes. The set of accessibility scores is indicative of the accessibility of the usage of the set of vehicles in each tile of the set of tiles. The one or more processors are further configured to determine the first accessibility score indicative of the accessibility of the usage of the set of vehicles in the first geographical region based on the determined set of accessibility scores.

In additional system embodiments, the one or more processors are further configured to generate a training dataset based on the obtained first set of parameters, the obtained second set of parameters, and the determined first accessibility score. The one or more processors are further configured to train a first machine learning (ML) model based on the generated training dataset. The first ML model is trained to determine an accessibility score for a geographical region.

In additional system embodiments, the one or more processors are further configured to obtain a third set of parameters associated with the consumption of the battery by the set of vehicles in a second geographical region. The one or more processors are further configured to obtain a fourth set of parameters associated with at least one of the set of vehicles or the set of charging points within the second geographical region. The one or more processors are further configured to apply the trained first ML model on the third set of parameters and the fourth set of parameters. The one or more processors are further configured to determine a second accessibility score based on an output of the first ML model. The second accessibility score is indicative of the accessibility of the usage of the set of vehicles in the second geographical region. The one or more processors are further configured to output the second accessibility score.

In additional system embodiments, the one or more processors are further configured to determine the first index based on an application of a second ML model on the obtained first set of parameters. The one or more processors are further configured to determine the second index based on an application of the second ML model on the obtained second set of parameters. The one or more processors are further configured to determine the first accessibility score based on the first index and the second index. The first accessibility score is indicative of the accessibility of the usage of the set of vehicles in the first geographical region.

In another aspect, a method for determination of the accessibility of a usage of vehicles in a geographical region is disclosed. The method includes obtaining a first set of parameters associated with a consumption of a battery by a set of vehicles in a first geographical region. The method further includes obtaining a second set of parameters associated with at least one of the set of vehicles or a set of charging points within the first geographical region. The method further includes determining a first index based on the obtained first set of parameters. The first index is indicative of the consumption of the battery by the set of vehicles in the first geographical region for a first time period. The method further includes determining a second index based on the obtained second set of parameters. The second index is indicative of the utilization of at least one of the set of vehicles or the set of charging points within the first geographical region for the first time period. The method further includes determining a first accessibility score based on the first index and the second index. The first accessibility score is indicative of the accessibility of a usage of the set of vehicles in the first geographical region for the first time period. The method further includes outputting the determined first accessibility score for the first time period.

In additional methods, the first set of parameters includes at least one of vehicle parameters associated with each vehicle of the set of vehicles, or geographical region parameters associated with the first geographical region.

In additional methods, the vehicle parameters are associated with at least one of a weight of each vehicle of the set of vehicles, a speed of each vehicle of the set of vehicles, a tire-size of each vehicle of the set of vehicles, an aerodynamic drag of each vehicle of the set of vehicles, an idling state of each vehicle of the set of vehicles, a battery size of each vehicle of the set of vehicles, a battery capacity of each vehicle of the set of vehicles or a battery consumption rate of each vehicle of the set of vehicles.

In additional methods, the second set of parameters is associated with at least one of mobility patterns of a user of each vehicle of the set of vehicles, a destination of each vehicle of the set of vehicles, a distance of each charging point of the set of charging points from each vehicle of the set of vehicles, an availability of each charging point of the set of charging points, or an infrastructure of the first geographical region.

In additional methods, the method further includes receiving a first user input associated with a destination of a first vehicle of the set of vehicles. The destination of the first vehicle is in the first geographical region. The method further includes determining the first accessibility score for the first geographical region based on the first user input. The method further includes determining a recommendation based on the first accessibility score and further output the determined recommendation.

In additional methods, the method further includes generating one or more navigation instructions to navigate the first vehicle toward the destination based on the determined recommendation. The method further includes controlling the first vehicle to navigate toward the destination based on the one or more navigation instructions.

In additional method embodiments, the method further includes determining a consumption score based on a first correlation of the first index with a consumption factor. The method further includes determining a utilization score based on a second correlation of the second index with a utilization factor. The method further includes determining the first accessibility score based on a third correlation of the consumption score with the utilization score.

In additional method embodiments, the method further includes generating a training dataset based on the obtained first set of parameters, the obtained second set of parameters, and the determined first accessibility score. The method further includes training a first machine learning (ML) model based on the generated training dataset. The first ML model is trained to determine an accessibility score for a geographical region.

In yet another aspect, a non-transitory computer-readable storage medium having computer program code instructions stored therein, the computer program code instructions, when executed by at least one processor, cause the at least one processor to obtain a first set of parameters associated with a consumption of a battery by a set of vehicles in a first geographical region. The computer program code instructions, when executed by at least one processor, cause the at least one processor to obtain a second set of parameters associated with at least one of the set of vehicles or a set of charging points within the first geographical region. The computer program code instructions, when executed by at least one processor, cause the at least one processor to determine the first index based on the obtained first set of parameters. The first index is indicative of the consumption of the battery by the set of vehicles in the first geographical region. The computer program code instructions, when executed by at least one processor, cause the at least one processor to determine a second index based on the obtained second set of parameters. The second index is indicative of the utilization of at least one of the set of vehicles or the set of charging points within the first geographical region. The computer program code instructions, when executed by at least one processor, cause the at least one processor to determine a first accessibility score based on the first index and the second index. The first accessibility score is indicative of the accessibility of a usage of the set of vehicles in the first geographical region. The computer program code instructions, when executed by at least one processor, cause the at least one processor to output the determined first accessibility score.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 is a diagram that illustrates a network environment for determination of accessibility of a usage of vehicles in a geographical region, in accordance with an embodiment of the disclosure;

FIG. 2 illustrates a block diagram of the system of FIG. 1, in accordance with an embodiment of the disclosure;

FIG. 3 is a block diagram that illustrates an exemplary first set of operations for the determination of the accessibility of the usage of the vehicles in the geographical region, in accordance with an embodiment of the disclosure;

FIG. 4 is a block diagram that illustrates an exemplary second set of operations for recommendation based on the accessibility of the usage of the vehicles in the geographical region, in accordance with an embodiment of the disclosure;

FIGS. 5A, and 5B are first exemplary diagrams that collectively depict user interface associated with the operations for the determination of the recommendation based on the accessibility of the usage of the vehicles in the geographical region, in accordance with an embodiment of the disclosure;

FIGS. 5C, and 5D are first exemplary diagrams that collectively depict user interface associated with the operations for the determination of the recommendation based on the accessibility of the usage of the vehicles in the geographical region, in accordance with an embodiment of the disclosure;

FIG. 6 is a block diagram that illustrates the training of a first machine learning (ML) model for the determination of a second accessibility score, in accordance with an embodiment of the disclosure;

FIG. 7A is a block diagram that illustrates the training of a second ML model for the determination of a first index, in accordance with an embodiment of the disclosure;

FIG. 7B is a block diagram that illustrates training of the second ML model for the determination of a second index, in accordance with an embodiment of the disclosure;

FIG. 8 is a flowchart that illustrates a first exemplary method for determination of the accessibility of the usage of vehicles in the geographical region, in accordance with an embodiment of the disclosure; and

FIG. 9 is a flowchart that illustrates a second exemplary method for determination of the accessibility of the usage of vehicles in the geographical region, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

The present disclosure may provide a system, a method, and a computer programmable product for determination of accessibility of a usage of vehicles in a geographical region. The disclosed system and the method provide techniques for determining an accessibility score for a geographical region. The accessibility score may be indicative of the accessibility of the usage of electric vehicles (EVs) in the first geographical region. In an embodiment, the accessibility score may be determined based on a first index and a second index. The first index may be indicative of the consumption of a battery by the EVs in the geographical region. Further, the second index may be indicative of the utilization of at least one of the EVs or a set of charging points within the geographical region. The techniques disclosed in the present disclosure may use a correlation of the first index and a second index to determine the first accessibility score.

The determination of the accessibility score allows for a mitigation of the challenges associated with the accessibility of the usage of the EVs in the geographical region. For example, the determination of the accessibility score may allow users of the EVs to determine whether it is convenient to travel in the geographical region by using the EVs, thereby increasing the user experience of the users of the EVs. In an embodiment, a low accessibility score (such as 40 percent) may indicate the users of the EVs to travel via another geographical region that may have a higher accessibility score (such as 60 percent), thereby enhancing the user's safety and experience.

In an embodiment, the higher accessibility score for another geographical region may be determined based on one or more best scenarios. The one or more best scenarios may be associated with the accessibility of the usage of the EVs in another geographical region. In an example embodiment, the one or more best scenarios include, but are not limited to, another geographical region with a flat terrain on which the EVs consumes less battery during driving, only the users of the EVs resides in another geographical region, a lot of charging points in another geographical region (such as 25, 30 or 40), a low waiting time (such as 15 minutes) in another geographical region for charging the EVs at the charging points, a temperature of another geographical region is around 20 degree Celsius, no traffic in another geographical region, a fast charging time (such as 20 minutes) for charging the EVs at the charging points, a high walkability for pedestrians in another geographical region, a large area of another geographical region is indicated by isolines, a presence of first point of interests (such as dining shops, entertainment centers, the parks, dedicated EV lane segments, EV reserved parking spaces, and the like) around the charging points for the users of the EVs, an ability of the charging points to satisfy high power demand for charging the EVs, and a low charging cost (such as 15 dollars, 20 dollars or 25 dollars) for charging the EVs at the charging points in another geographical region. In an embodiment, the high walkability is indicative of the presence of a second point of interest (such as sidewalks, pedestrian crossings, schools, parks, and the like) within a short walking distance (such as 15 minutes, 20 minutes, or 20 minutes). In an embodiment, the isolines are indicative of at least one area of another geographical region that has a high accessibility score (such as 75 percent) for driving the EVs.

In an embodiment, the low accessibility score for the geographical region may be determined based on one or more worse scenarios. The one or more worse scenarios may be associated with the accessibility of the usage of the EVs in the geographical region. In an example embodiment, the one or more worst scenarios includes, but are not limited to, low availability of the geographical region with high slopes on which a consumption of the battery may increase during driving of EVs, a lot of the EVs (such as 100, 150, or 200) in the geographical region, a high occupancy of the charging points for charging the EVs, a slow charging time (such as 40 minutes) for charging the EVs at the charging points, an absence of the first point of interests in the geographical region, a high charging cost for charging the EVs at the charging points, a high occurrence of icing events in the geographical region, a high occurrence of scratching events in the geographical region, a high occurrence of unplugging events in the geographical region, a grid instability in the geographical region, a high occurrence of malicious acts in the geographical region, a low network strength for payment for charging the EVs at the charging points in the geographical region, an unavailability of service stations in the geographical region for maintenance of the EVs, and low EV charging struggle index associated with the charging of the EVs at the charging points. In an embodiment, the icing events in the geographical region may correspond to an occupancy of one or more reserved parking areas for the EVs by internal combustion engine (ICE) vehicles. In an embodiment, the scratching events in the geographical region may correspond to the scratching of the EVs by other vehicles. In an embodiment, the malicious acts in the geographical region may correspond to damage to the EVs, theft of the EVs, and the like. In an embodiment, the grid instability may correspond to the instability of an electrical grid to maintain consistent voltage across a network distributed in the geographical region. In an embodiment, an EV charging struggle index may be indicative of challenges (such as low availability of the charging points, high charging cost, and the like) associated with the charging of the EVs at the charging points.

In another embodiment, the determination of the accessibility score may allow the users of the EVs to determine a range of a new EV for driving in the geographical region. For example, the low accessibility score may indicate a limited number of charging points in the geographical region. In such a case, a new EV with a greater range is required to reduce the need for frequent charging in the geographical region. In yet another embodiment, the determination of the accessibility score may allow the users of the EVs to determine whether there is a need to buy the new EV for driving in the geographical region.

In an embodiment, various users (such as city planners, municipalities workers, government, and the like) associated with the geographical region may utilize the determined accessibility score to determine a need for improvement in infrastructure (such as charging points, roads, and the like) associated with the geographical region. For example, the low accessibility score may be indicative of a need for an increase in the number of the charging points in the corresponding geographical region. Additionally, the determination of the accessibility score allows for the determination of a need for the deployment of mobile charging points in the geographical region. In another example, the low accessibility score may be indicative of bad road conditions in the geographical region. To that end, the low accessibility score may allow city planners to determine plans for the improvement of the infrastructure, leading to an increase in the convenience of residents associated with the geographical region and an increase in economic growth within the geographical region. In an embodiment, the determination of the accessibility score may allow the government to determine incentives for users of EVs for increasing adoption of the EVs in the geographical region. In an embodiment, the determined accessibility score may be indicative of a change in trends for at least one area in the geographical region. In an embodiment, the change in the trends may be indicative of a change in at least one of the first index or the second index. The first index may be indicative of the consumption of a battery by the EVs in the geographical region. Further, the second index may be indicative of the utilization of at least one of the EVs or the set of charging points within the geographical region. In another embodiment, the determination of the accessibility score may allow the users of the EVs to determine their future accommodations or travel plans in the geographical region. In an embodiment, real estate companies may promote geographical region(s) with the higher accessibility score to the users of the EVs to determine their future accommodations or travel plans in the geographical region. In another embodiment, the determination of the accessibility score may allow various companies (such as real estate companies) to identify potential geographical regions for real estate projects. Additionally, in yet another embodiment, the determination of the accessibility score may allow for the determination of navigation features for the geographical region. The navigation features may be associated with a location of preferred routes of the users of the EVs, or driving behavior (such as average speed, acceleration patterns, braking patterns, and the like) of the users of the EVs. Further, a high level trajectory point dataset may be generated based on the navigation features. Further, the high level trajectory point dataset may be utilized for routing operations of the EVs, or a computation of a risk factor associated with the driving of EVs in the geographical region. The risk factor may be indicative of a risk (such as an accident) associated with driving EVs in the geographical region. Additionally, the computation of the risk factor allows for the determination of hostile areas for the EVs in the geographical region. In an embodiment, the navigation features may be sold to OEMs or real estate companies. In an embodiment, the determination of accessibility score may allow various users (such as original equipment manufacturers (OEMs) associated with the EV industry to predict an adoption of EVs in the geographical region. The prediction of the adoption of EVs in the geographical region may allow the OEMs to determine market opportunities for selling new EVs in the geographical region. Additionally, the prediction of the adoption of the EVs in the geographical region may provide the OEMs with first movers advantage, leading to a competitive advantage in dealership planning for the EVs in the geographical region. In an embodiment, the determination of the accessibility score may allow the ride sharing companies to determine a plan for providing EV shared vehicle services. In another embodiment, the determination of the accessibility score allows the determination of marketing plans for EV technology companies (such as HERE Technologies) to indicate thought leadership. Additionally, or alternatively, the EV technology companies may sell technological data or products for the determination of the accessibility score associated with the geographical region. The technological data may be associated with a road topology of the geographical region, the first point of interest for the users of EVs.

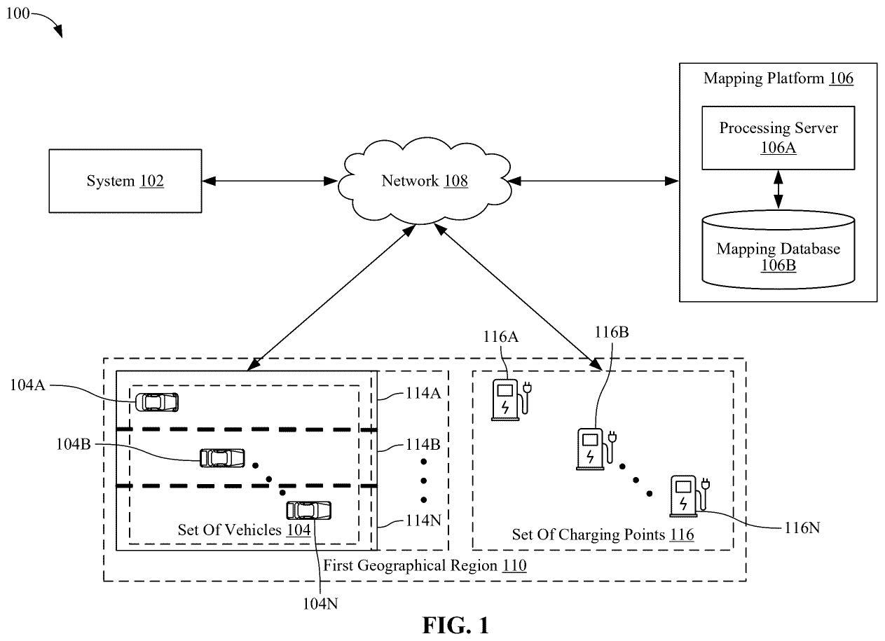

FIG. 1 is a diagram that illustrates a network environment for the determination of accessibility of a usage of vehicles in a geographical region, in accordance with an embodiment of the disclosure. With reference to FIG. 1, there is shown a diagram of the network environment 100. The network environment 100 includes a system 102, a set of vehicles 104, a mapping platform 106, and a network 108. The mapping platform 106 may include a processing server 106A and a mapping database 106B. With reference to FIG. 1, there is further shown a first geographical region 110 and may include a road segment 112 and a set of charging points 116. The set of vehicles 104 may be traveling on the road segment 112 and may include a first vehicle 104A, a second vehicle 104B, up to an Nth vehicle 104N. In an embodiment, the road segment 112 may include a set of lane segments 114. The set of lane segments 114 may include a first lane segment 114A, a second lane segment 114B, up to an Nth lane segment 114N. In an embodiment, the set of charging points 116 may be situated proximate to the road segment 112. Specifically, the set of charging points 116 may be situated proximate to the set of lane segments 114. The set of charging points 116 may include a first charging point 116A, a second charging point 116B, and up to an Nth charging point 116N. In an embodiment, the set of charging points 116 may be situated proximate to the road segment 112. In an embodiment, the system 102 may be associated with the first vehicle 104A of the set of vehicles 104. In another embodiment, the system 102 may be integrated with the first vehicle 104A of the set of vehicles 104.

The system 102 may include suitable logic, circuitry, interfaces, and/or code that may be configured to determine an accessibility score indicative of a usage of the set of vehicles 104 in the first geographical region 110. In an embodiment, the system 102 may be configured to obtain a first set of parameters associated with a consumption of a battery by the set of vehicles 104 in the first geographical region 110. The system 102 may be further configured to obtain a second set of parameters associated with at least one of the set of vehicles 104 or the set of charging points 116 within the first geographical region 110. Based on the obtained first set of parameters, the system 102 may be configured to determine a first index indicative of the consumption of the battery by the set of vehicles 104 in the first geographical region 110. Further, based on the obtained second set of parameters, the system 102 may be configured to determine a second index indicative of a utilization of at least one of the set of vehicles 104 or the set of charging points 116 within the first geographical region 110. Based on the first index and the second index, the system 102 may be further configured to determine a first accessibility score indicative of the accessibility of the usage of the set of vehicles 104 in the first geographical region 110. Thereafter, the system 102 may be configured to output the determined first accessibility score. Examples of the system 102 may include, but are not limited to, an electronic control unit (ECU) of the first vehicle 104A, an electronic control module (ECM) of the first vehicle 104A, a computing device, a mainframe machine, a server, a computer workstation, any and/or any other device associated with accessibility of vehicle usage determination operations.

In an example embodiment, the system 102 may be on-boarded by the first vehicle 104A, such as the system 102 may be a vehicle usage accessibility system installed in the first vehicle 104A for determining the accessibility of the usage of the set of vehicles 104 in the first geographical region 110. In another example embodiment, the system 102 may be the processing server 106A of the mapping platform 106 and therefore may be co-located with or within the mapping platform 106.

In another embodiment, the system 102 may be embodied as a cloud-based service, a cloud-based application, a cloud-based platform, a remote server-based service, a remote server-based application, a remote server-based platform, or a virtual computing system. In yet another example embodiment, the system 102 may be an OEM (Original Equipment Manufacturer) cloud. The OEM cloud may be configured to anonymize any data received by the system 102, such as data associated with the first set of parameters or the second set of parameters, before using the data for further processing, such as before sending the data to the mapping database 106B. For an example, anonymization of the data may be done by the mapping platform 106.

Each vehicle of the set of vehicles 104 may be a non-autonomous vehicle, a semi-autonomous vehicle, or a fully autonomous vehicle, for example, as defined by the National Highway Traffic Safety Administration (NHTSA). Examples of each vehicle of the set of vehicles 104 may include, but are not limited to, a two-wheeler vehicle, a three-wheeler vehicle, a four-wheeler vehicle, more than a four-wheeler vehicle, an electric vehicle, a hybrid vehicle, or a vehicle with autonomous drive capability that uses one or more distinct renewable or non-renewable power sources. The vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. Each vehicle of the set of vehicles 104 may be a system through which an occupant (for example a rider) may travel from a start point to a destination point. Examples of the two-wheeler vehicle may include, but are not limited to, an electric two-wheeler, or a hybrid two-wheeler. Similarly, examples of the four-wheeler vehicles may include, but are not limited to, an electric car, a fuel-cell-based car, a solar-powered car, or a hybrid car. It may be noted here that the four-wheeler diagram of each of the set of vehicles 104 is merely shown as examples in FIG. 1. The present disclosure may also be applicable to other structures, designs, or shapes of each of the set of vehicles 104. The description of other types of vehicles and respective structures, designs, or shapes has been omitted from the disclosure for the sake of brevity.

In some example embodiments, each vehicle of the set of vehicles 104 may include processing means such as a central processing unit (CPU), storage means such as on-board read-only memory (ROM), random access memory (RAM), acoustic sensors such as a microphone array, position sensors such as a global positioning system (GPS) sensor, gyroscope, a light detection and ranging (LiDAR) sensor, a proximity sensor, motion sensors such as an accelerometer, an image sensor such as a camera, a display enabled user interface such as a touch screen display, and other components as may be required for specific functionalities of each vehicle of the set of vehicles 104. In some example embodiments, a user equipment may be associated, coupled, or otherwise integrated with the set of vehicles 104, such as an advanced driver assistance system (ADAS), a personal navigation device (PND), a portable navigation device, and/or other devices that may be configured to provide route guidance and navigation-related functions to the user.

In an embodiment, each vehicle of the set of vehicles 104 may include an infotainment system. The infotainment system may include suitable logic, circuitry, interfaces, and/or code that may be configured to render at least audio-based data, or video-based data, on the user interface in the corresponding vehicle of the set of vehicles 104. For example, the infotainment system may include a display screen to display the user interface on which the video-based data may be displayed. In another example, the infotainment system may include a plurality of speakers to output the audio-based data. In such an example, the audio-based data may include, but is not limited to, audio content rendered on the plurality of speakers communicatively coupled to the user interface. The infotainment system may be configured to render the determined first accessibility score for the first geographical region 110. Examples of the infotainment systems may include, but are not limited to, an entertainment system, a navigation system, a vehicle user interface system, an Internet-enabled communication system, and other entertainment systems.

The mapping platform 106 may include suitable logic, circuitry, and interfaces that may be configured to store one or more map attributes and sensor data associated with traffic on the set of lane segments 114. The mapping platform 106 may be configured to store and update map data indicating the traffic data along with other map attributes, road attributes, and traffic entities, in the mapping database 106B. The mapping platform 106 may include techniques related to, but not limited to, geocoding, routing (multimodal, intermodal, and unimodal), clustering algorithms, machine learning in location-based solutions, natural language processing algorithms, and artificial intelligence algorithms. Data for different modules of the mapping platform 106 may be collected using a plurality of technologies including, but not limited to drones, sensors, connected cars, cameras, probes, and chipsets. In some embodiments, the mapping platform 106 may be embodied as a chip or chip set. In other words, the mapping platform 106 may include one or more physical packages (such as chips) that include materials, components, and/or wires on a structural assembly (such as a baseboard).

In some example embodiments, the mapping platform 106 may include the processing server 106A for carrying out the processing functions associated with the mapping platform 106 and the mapping database 106B for storing map data. In an embodiment, the processing server 106A may include one or more processors configured to process requests received from the system 102. The processors may fetch sensor data and/or map data from the mapping database 106B and transmit the same to the system 102 in a format suitable for use by the system 102.

Continuing further, the mapping database 106B may include suitable logic, circuitry, and interfaces that may be configured to store the sensor data and map data, which may be collected from the first vehicle 104A. In an embodiment, the first vehicle 104A may be traveling on the road segment 112 in the first geographical region 110. In accordance with an embodiment, such sensor data may be updated in real-time or near real-time such as within a few seconds, a few minutes, or on an hourly basis, to provide accurate and up-to-date sensor data. The sensor data may be collected from any sensor that may inform the mapping platform 106 or the mapping database 106B of features within an environment that is appropriate for traffic-related services. In accordance with an embodiment, the sensor data may be collected from any sensor that may inform the mapping platform 106 or the mapping database 106B of features within an environment that is appropriate for mapping. For example, motion sensors, inertia sensors, image capture sensors, proximity sensors, LiDAR sensors, and ultrasonic sensors may be used to collect the sensor data. The gathering of massive quantities of crowd-sourced data may facilitate the accurate modeling and mapping of an environment, whether it is a road link or a link within a structure, such as in an interior of a multi-level parking structure.

The mapping database 106B may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the mapping database 106B may be configured to receive the map data including the road topology and geometry-related attributes related to the road network from external systems, such as one or more of background batch data services, streaming data services, and third-party service providers, via the network 108.

In accordance with an embodiment, the map data stored in the mapping database 106B may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the mapping database 106B may further store historical probe data for events (such as, but not limited to, traffic incidents, construction activities, scheduled events, and unscheduled events) associated with Point of Interest (POI) data records or other records of the mapping database 106B.

For example, the data stored in the mapping database 106B may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received mapping database 106B in a delivery format to produce one or more compiled navigation databases.

In some embodiments, the mapping database 106B may be a master geographic database configured on the side of the system 102. In accordance with an embodiment, the mapping database 106B may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-user vehicles (such as the first vehicle 104A) which use vehicles on-board one or more sensors to detect data about various entities such as road objects, lane markings, links, and the like. These vehicles are also referred to as probe vehicles and form an alternate form of data source for map data collection, along with ground truth data. Additionally, data collection mechanisms like remote sensing, such as aerial or satellite photography may be used to collect the map data for the mapping database 106B.

For an example, the mapping database 106B may include lane and intersection data records or other data that may represent links in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations, hotels, restaurants, museums, stadiums, offices, auto repair shops, buildings, stores, and parks. The mapping database 106B may additionally include data about places, such as cities, towns, or other communities, and other geographic features such as, but not limited to, bodies of water, and mountain ranges.

In some example embodiments, images received from the image source may be stored within the mapping database 106B of the mapping platform 106. In certain cases, the mapping platform 106, using the processing server 106A, may suitably process the received images. For example, such processing may include, suitably labeling the images based on corresponding associated lane and/or link, point of interest within the link and/or lane, and other information relating to the respective link and/or lane. Such labeled images may then be stored within the mapping database 106B as map data.

The network 108 may be wired, wireless, or any combination of wired and wireless communication networks, such as cellular, Wi-Fi, internet, local area networks, or the like. In some embodiments, the network 108 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, international telecommunication union (ITU)-international mobile communications (IMT) 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In operation, a user of the first vehicle 104A may be planning to navigate to (or via) the first geographical region 110. For example, the user of the first vehicle 104A may be planning from a first location (say his/her home) to a second location (say his/her office) in the first geographical region 110 using the first vehicle 104A. In an embodiment, the users of the first vehicle 104A may determine the first accessibility score to navigate (or via) the first geographical region. The first accessibility score may be indicative of the accessibility of the usage of the set of vehicles 104 in the first geographical region 110. The determination of the first accessibility score may allow the user of the first vehicle 104A to determine whether it is convenient to navigate in the first geographical region 110 using the first vehicle 104A, leading to an increase in the driving experience of the user of the first vehicle 104A. In an embodiment, various factors associated with the first geographical region 110 may decrease the accessibility of the usage of the first vehicle 104A in the first geographical region 110. For example, driving on uneven road segments in the first geographical region 110 may decrease the battery level of the first vehicle 104A, leading to an inability of the first vehicle 104A to reach the second location. Further, weather conditions associated with the first geographical region 110 may decrease the performance of the first vehicle 104A during driving in the first geographical region 110. Moreover, the limited availability of the set of charging points 116 within the first geographical region 110 may further lead to a decrease in the accessibility of the usage of the first vehicle in the first geographical region 110. For example, the limited availability of the set of charging points 116 may lead to challenges associated with the charging of the first vehicle 104A. To overcome challenges associated with a decrease in the accessibility of the usage of the first vehicle 104A in the first geographical region 110, the system 102 may be configured to determine the first accessibility score. The first accessibility score may be indicative of the accessibility of the usage of the set of vehicles 104 in the first geographical region 110. The determination of the first accessibility score may allow the user of the first vehicle 104A.

In an embodiment, the system 102 may be configured to obtain the first set of parameters associated with the consumption of the battery by the set of vehicles 104 in the first geographical region 110. The system 102 may be further configured to obtain the second set of parameters associated with at least one of the set of vehicles 104 or the set of charging points 116 within the first geographical region 110. Based on the obtained first set of parameters, the system 102 may be configured to determine the first index indicative of the consumption of the battery by the set of vehicles 104 in the first geographical region 110. Further, based on the obtained second set of parameters, the system 102 may be configured to determine the second index indicative of the utilization of at least one of the set of vehicles 104 or the set of charging points 116 within the first geographical region 110. Based on the first index and the second index, the system 102 may be further configured to determine the first accessibility score indicative of the accessibility of the usage of the set of vehicles 104 in the first geographical region 110.

The system 102 may be configured to output the determined first accessibility score. In an embodiment, the system 102 may be configured to output the first accessibility score on the user interface associated with the first vehicle 104A of the set of vehicles 104. In another embodiment, the system 102 may be configured to render an audio output indicative of the determined first accessibility score.

In an embodiment, the system 102 may be communicatively coupled to each vehicle of the set of vehicles 104, and the mapping platform 106, via the network 108. In an embodiment, the system 102 may be communicatively coupled to other components not shown in FIG. 1 via the network 108. All the components in the network environment 100 may be coupled directly or indirectly to the network 108. The components described in the network environment 100 may be further broken down into more than one component and/or combined together in any suitable arrangement. Further, one or more components may be rearranged, changed, added, and/or removed.

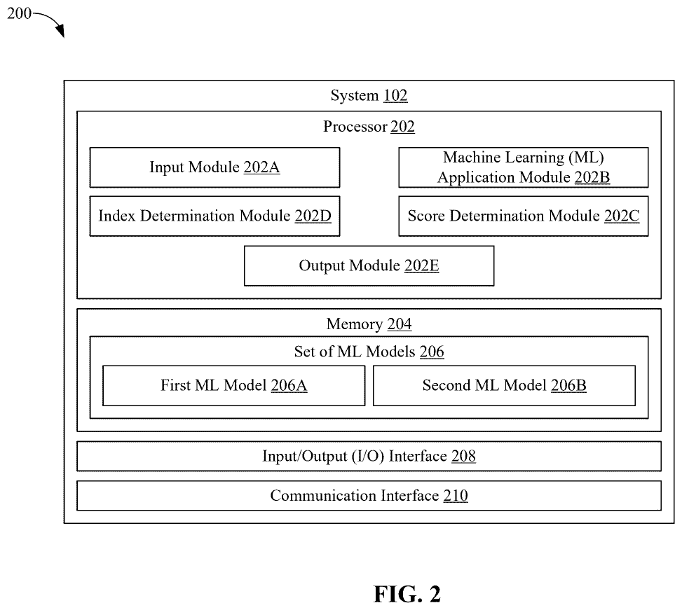

FIG. 2 illustrates a block diagram 200 of the system of FIG. 1, in accordance with an embodiment of the disclosure. FIG. 2 is explained in conjunction with FIG. 1. In FIG. 2, there is shown the block diagram 200 of the system 102. The system 102 may include at least one processor 202 (referred to as a processor 202, hereinafter), at least one non-transitory memory 204 (referred to as a memory 204, hereinafter), a set of ML models 206, an input/output (I/O) interface 208, and a communication interface 210. The processor 202 may include modules, depicted as, an input module 202A, an ML application module 202B, an index determination module 202C, a score determination module 202D, and an output module 202E. The system 102 may be connected to the memory 204, and the I/O interface 208 through wired or wireless connections. Although in FIG. 2, it is shown that the system 102 includes the processor 202, the memory 204, and the I/O interface 208 however, the disclosure may not be so limiting and the system 102 may include fewer or more components to perform the same or other functions of the system 102. In an embodiment, the input module 202A, and the output module 202E may be integrated within the I/O interface 208. In some embodiments, the input module 202A may receive input data (such as user inputs), and the output module 202E may output processed data (such as the determined first index, the determined second index, the determined first accessibility score, and the like) via the I/O interface 208.

In accordance with an embodiment, the system 102 may store data that may be generated by the modules while performing corresponding operations or may be retrieved from a database associated with the system 102, such as the mapping database 106B, in the memory 204. For example, the data may include vehicle information, traffic information, user information, distance information, and environmental information.

The processor 202 of the system 102 may be configured to determine the first accessibility score for the first geographical region 110 and output the determined first accessibility score. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

In an example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment 100 may be accessed using the communication interface 210 of the system 102. The communication interface 210 may provide an interface for accessing various features and data stored in the system 102.

In some embodiments, the processor 202 may be configured to provide Internet-of-Things (IoT) related capabilities to users of the system 102 disclosed herein. The IoT-related capabilities may in turn be used to provide smart city solutions by providing the recommendation associated with the accessibility of the usage of the set of vehicles 104 in the first geographical region 110 real-time warnings, big data analysis, and sensor-based data collection by using the cloud-based mapping system for providing accurate navigation instructions and ensuring driver safety. The I/O interface 208 may provide an interface for accessing various features and data stored in the system 102.

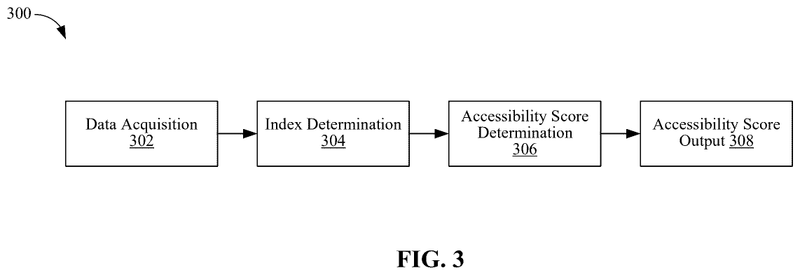

The input module 202A of the processor 202 may be configured to obtain the first set of parameters associated with the consumption of the battery by the set of vehicles 104 in the first geographical region 110. The first set of parameters may include at least one of vehicle parameters associated with each vehicle of the set of vehicles 104, or geographical region parameters associated with the first geographical region 110. In an embodiment, the vehicle parameters are associated with at least one of a weight of each vehicle of the set of vehicles 104, a speed of each vehicle of the set of vehicles 104, a tire-size of each vehicle of the set of vehicles 104, an aerodynamic drag of each vehicle of the set of vehicles 104, an idling state of each vehicle of the set of vehicles 104, a battery size of each vehicle of the set of vehicles 104, a battery capacity of each vehicle of the set of vehicles 104, or a battery consumption rate of each vehicle of the set of vehicles 104. In another embodiment, the geographical region parameters are associated with the location of the first geographical region 110, the directionality of each lane segment of the set of lane segments 114 an elevation of the first geographical region 110 with respect to sea level, a terrain of the first geographical region 110, an average steepness of slopes in the first geographical region 110, and weather patterns associated with the first geographical region 110. Details about the first set of parameters are provided, for example, in FIG. 3.

In an embodiment, the input module 202A may be further configured to obtain the second set of parameters associated with at least one of the set of vehicles 104 or the set of charging points 116 within the first geographical region 110. The second set of parameters is associated with at least one of mobility patterns of a user of each vehicle of the set of vehicles 104, the destination of each vehicle of the set of vehicles 104, a distance of each charging point of the set of charging points 116 from each vehicle of the set of vehicles 104, an availability of each charging point of the set of charging points 116, or an infrastructure of the first geographical region 110. Details about the second set of parameters are provided, for example, in FIG. 3.

The ML application module 202B of the processor 202 may be configured to apply the set of ML models 206 to determine at least one of the first index or the second index. In an embodiment, the set of ML models 206 may be trained to identify a relationship between the set of inputs, such as a set of features in a training dataset, and output predictive values. The set of ML models 206 may be defined by its hyper-parameters, for example, a number of weights, cost function, input size, number of layers, and the like. The hyper-parameters of the set of ML models 206 may be tuned and weights may be updated to move towards a global minimum of a cost function for the corresponding ML model. After several epochs of the training on the feature information in the training dataset, the set of ML models 206 may be trained to output a prediction for the set of inputs. In an embodiment, the prediction may be associated with the consumption of the battery by the set of vehicles 104 in the first geographical region 110. In another embodiment, the prediction may be associated with the utilization of at least one of the set of vehicles 104 or the set of charging points 116 within the first geographical region 110. In yet another embodiment, the prediction may be associated with the accessibility of the usage of the set of vehicles 104 in at least one geographical region.

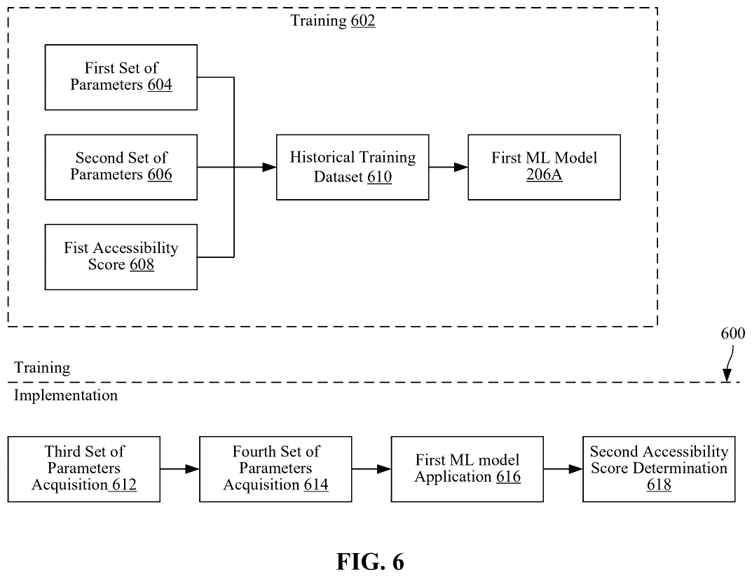

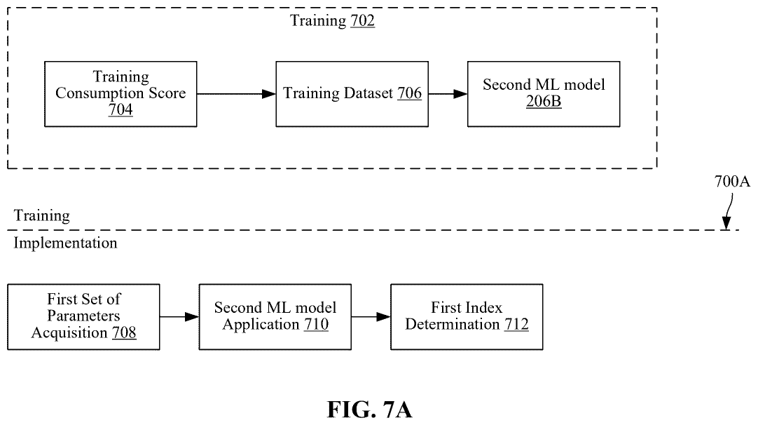

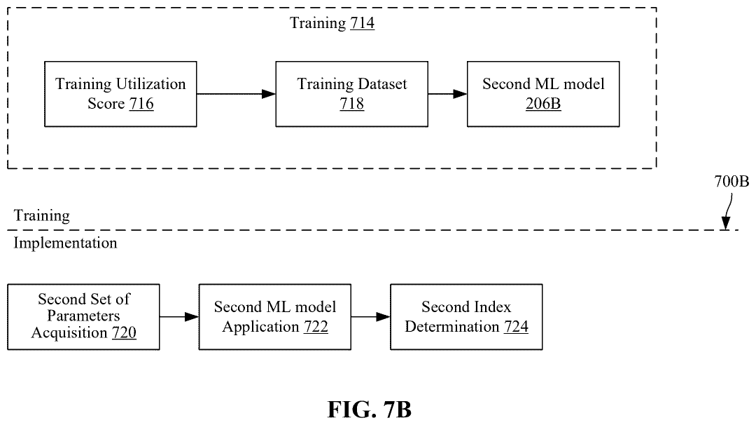

Each of the set of ML models 206 (such as the first ML model 206A and the second ML model 206B) may include electronic data, such as, for example, a software program, code of the software program, libraries, applications, scripts, or other logic or instructions for execution by a processing device, such as the system 102. The set of ML models 206 may include code and routines configured to enable a computing device, such as the system 102 to perform one or more operations associated with the determination of the accessibility of the usage of the set of vehicles 104 in the at least one geographical region. In an embodiment, the first ML model 206A may be trained to determine an accessibility score for the at least one geographical region. Specifically, the first ML model 206A may be trained to determine a second accessibility score for a second geographical region. In an embodiment, the second geographical region may be situated proximate to the first geographical region 110. Details about an implementation of the first ML model 206A for determination of the second accessibility score are provided, for example, in FIG. 6. In an embodiment, the second ML model 206B may be trained to determine the first index for the first geographical region 110. The first index may be indicative of the consumption of the battery by the set of vehicles 104 in the first geographical region 110. Specifically, the second ML model 206B may be trained to output the first index. Details about the implementation of the second ML model 206B for determination of the first index are provided, for example, in FIG. 7A. In another embodiment, the second ML model 206B may be trained to determine the second index for the first geographical region 110. The second index may be indicative of the utilization of at least one of the set of vehicles 104 or the set of charging points 116 within the first geographical region 110. Specifically, the second ML model 206B may be trained to output the second index. Details about the implementation of the second ML model 206B are provided, for example, in FIG. 7B.

Additionally, or alternatively, the set of ML models 206 may be implemented using hardware including a processor, a microprocessor (e.g., to perform or control the performance of one or more operations), a field-programmable gate array (FPGA), or an application-specific integrated circuit (ASIC). Alternatively, in some embodiments, the set of ML models 206 may be implemented using a combination of hardware and software. Examples of the set of ML models 206 may include, but are not limited to, a Deep Neural Network (DNN), an Artificial Neural Network (ANN), a Convolutional Neural Network (CNN), or a combination thereof.

The index determination module 202C of the processor 202 may be configured to determine the first index based on the obtained first set of parameters. The first index may be indicative of the consumption of the battery by the set of vehicles 104 in the first geographical region 110. In an embodiment, the index determination module 202C may be configured to determine the first index based on a first output of the second ML model 206B. In an embodiment, the first output may correspond to the prediction associated with the consumption of the battery by the set of vehicles 104 in the first geographical region 110. In an embodiment, the index determination module 202C may be further configured to determine the second index based on the obtained second set of parameters. The second index may be indicative of the utilization of at least one of the set of vehicles 104 or the set of charging points 116 within the first geographical region 110. In an embodiment, the index determination module 202C may be configured to determine the second index based on a second output of the second ML model 206B. In an embodiment, the second output may correspond to the prediction associated with the utilization of at least one of the set of vehicles 104 or the set of charging points 116 within the first geographical region 110.

The score determination module of the processor 202 may be configured to determine the first accessibility score based on the determined first index and the determined second index. The first accessibility score may be indicative of the accessibility of the usage of the set of vehicles 104 in the first geographical region 110. Details about the determination of the first accessibility score are provided, for example, in FIG. 3.

The output module 202E of the processor 202 may be configured to output the determined first index, the determined second index, and/or the determined first accessibility score. In an embodiment, the output module 202E may be configured to generate one or more virtual objects indicating the determined first index, the determined second index, the determined first accessibility score, or a combination thereof. In another embodiment, the output module 202E may be configured to alert the user of each vehicle of the set of vehicles 104 about the determined first accessibility score. The output module 202E may be further configured to output the generated one or more virtual objects and the audio alerts on the I/O interface 208 of the system 102. In another embodiment, the output module 202E of the processor 202 may be configured to transmit the at least one of the determined first index, the determined second index, or the determined first accessibility score to the mapping database 106B. In another embodiment, based on the determined first accessibility score, the output module 202E of the processor 202 may be configured to control the maneuver of at least one vehicle of the set of vehicles 104A within the first geographical region 110.

The memory 204 of the system 102 may be configured to store the first index, the second index, and the first accessibility score. In an embodiment, the memory 204 may be configured to store the first ML model 206A and the second ML model 206B. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

In some example embodiments, the I/O interface 208 may communicate with the system 102 and display the input and/or output of the system 102. As such, the I/O interface 208 may include a display and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or I/O interface 208 circuitry comprising the processor 202 may be configured to control one or more functions of one or more I/O interface 208 elements through computer program instructions (for example, software and/or firmware) stored on a memory 204 accessible to the processor 202.

The communication interface 210 may include an input interface and output interface for supporting communications to and from the system 102 or any other component with which the system 102 may communicate. The communication interface 210 may be any means such as a device or circuitry embodied in either hardware or a combination of hardware and software that is configured to receive and/or transmit data to/from a communications device in communication with the system 102. In this regard, the communication interface 210 may include, for example, an antenna (or multiple antennae) and supporting hardware and/or software for enabling communications with a wireless communication network. Additionally, or alternatively, the communication interface 210 may include the circuitry for interacting with the antenna(s) to cause transmission of signals via the antenna(s) or to handle receipt of signals received via the antenna(s). In some environments, the communication interface 210 may alternatively or additionally support wired communication. As such, for example, the communication interface 210 may include a communication modem and/or other hardware and/or software for supporting communication via cable, digital subscriber line (DSL), universal serial bus (USB), or other mechanisms. In some embodiments, the communication interface 210 may enable communication with a cloud-based network to enable deep learning, such as using the set of ML models 206 (that may be hosted on the cloud-based network).

FIG. 3 is a block diagram 300 that illustrates an exemplary first set of operations for the determination of the accessibility of the usage of the vehicles in the geographical region, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 308, as described herein. The exemplary operations illustrated in the block diagram 300 may start at 302 and may be performed by any computing system, apparatus, or device, such as by the system 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the particular implementation.

In an embodiment, the exemplary operations from 302 to 308 may be executed based on a reception of a user input from at least one user associated with the determination of the first accessibility score for the first geographical region 110. In an example embodiment, the at least one user may correspond to at least one of various companies (such as the real estate companies, vehicle charging companies), users of the set of vehicles 104, the city planners, the municipalities workers, and the government.

At 302, a data acquisition operation may be executed. In the data acquisition operation, the system 102 may be configured to obtain the first set of parameters. Specifically, the input module 202A of the processor 202 may be configured to obtain the first set of parameters. The first set of parameters may be associated with the consumption of the battery by the set of vehicles 104 in the first geographical region. The first set of parameters may include at least one of the vehicle parameters associated with each vehicle of the set of vehicles 104, or the geographical region parameters associated with the first geographical region 110. In an embodiment, the system 102 may be configured to obtain the first set of parameters for a first time period (such as 1 day, 1 week, 1 month, and 3 months).

In an embodiment, the vehicle parameters may be associated with at least one of a weight of each vehicle of the set of vehicles 104, a speed of each vehicle of the set of vehicles 104, a tire-size of each vehicle of the set of vehicles 104, an aerodynamic drag of each vehicle of the set of vehicles 104, an idling state of each vehicle of the set of vehicles 104, a battery size of each vehicle of the set of vehicles 104, a battery capacity of each vehicle of the set of vehicles 104, or a battery consumption rate of each vehicle of the set of vehicles 104.

In an example embodiment, the weight of each vehicle of the set of vehicles 104 may be, for example, but is not limited to, 3000 pounds, 3600 pounds, or 4400 pounds. In an example embodiment, the speed of each vehicle of the vehicle 104 may be, for example, but is not limited to, 25 miles per hour (mph), 30 mph, 55 mph, or 75 mph. In an embodiment, the tire size of each vehicle of the set of vehicles 104 may correspond to the diameter of the tires of the set of vehicles. In an example embodiment, the tire-size of each vehicle of the set of vehicles 104 may be, for example, but is not limited to, 14 inches, 16 inches, 18 inches, or 22 inches. In an embodiment, the aerodynamic drag of each vehicle of the set of vehicles 104 may correspond to a force that opposes a motion of the set of vehicles 104 through air. In an embodiment, the aerodynamic drag of the first vehicle 104A may be computed based on the density of the air, the speed of the first vehicle 104A with respect to the air, the drag coefficient of the first vehicle 104A, and a frontal area of the first vehicle 104A. In an example embodiment, the aerodynamic drag of the first vehicle 104A may be, for example, but is not limited to, 0.25 aerodynamic drag coefficient (Cd), 0.35 Cd, 0.40 Cd or 0.55 Cd. In an embodiment, the idling state of each vehicle of the set of vehicles 104 may correspond to a stagnant state of the set of vehicles 104 in traffic on the road segment 112 for a first duration. In an example embodiment, the first duration, may be, for example, 10 minutes, 15 minutes, 20 minutes, or 1 hour. In an embodiment, the battery size of each vehicle of the set of vehicles 104 may correspond to at least one of the dimensions of the battery of each vehicle of the set of vehicles 104 or the weight of the battery associated with the set of vehicles 104. In an example embodiment, the first dimensions of a first battery associated with the first vehicle 104A may include, but are not limited to, the length of the first battery (such as 1.5 meters), the width of the first battery (such as 1.0 meters) and a height of the first battery (such as 0.3 meters). In another example embodiment, the first weight of the first battery associated with the first vehicle 104A may be, for example, but is not limited to, 650 pounds, 800 pounds, 950 pounds, or 1100 pounds. In an embodiment, the battery capacity of each vehicle of the set of vehicles 104 may correspond to the maximum amount of charge that the battery of the set of vehicles 104 may store. In an example embodiment, the first battery capacity of the first vehicle 104A may be, for example, but is not limited to, 45 kilowatt hours (kWh), 60 kWh, or 100 kWh. In an embodiment, the battery consumption rate of each vehicle of the set of vehicles 104 may correspond to the amount of charge that the battery of the set of vehicles 104 may consume with respect to the distance travelled by the set of vehicles 104. In an example embodiment, the battery consumption rate of the first vehicle 104A may be, for example, 18 kWh/100 miles (mi), 20 kWh/100 mi, or 25 kWh/100 mi.

In another embodiment, the geographical region parameters are associated with the location of the first geographical region 110, the directionality of each lane segment of the set of lane segments 114, the elevation of the first geographical region 110 with respect to the sea level, the terrain of the first geographical region 110, the average steepness of slopes in the first geographical region 110, and weather patterns associated with the first geographical region 110.

In an example embodiment, the location of the first geographical region 110 may correspond to geographical coordinates associated with the first geographical region 110. In an embodiment, the directionality of each lane segment of the set of lane segments 114 may correspond to a predefined direction for a flow of traffic on the corresponding lane segment of the set of lane segments 114. In an embodiment, the elevation of the first geographical region 110 may correspond to the height of the first geographical region 110 with respect to the sea level. In an example embodiment, the elevation of the first geographical region 110 may be, for example, but is not limited to, 650 meters. In an embodiment, the terrain of the first geographical region 110 may correspond to at least one portion of the first geographical region with a first set of physical features (such as the soil type of the first geographical region, the elevation of the first geographical region 110, and the like). The terrain of the first geographical region 110 may include, but is not limited to, mountains, plains, valleys, or plateaus. In an embodiment, the average steepness of the slopes in the first geographical region 110 may correspond to an angle of inclination with respect to a horizontal plane. The average steepness of slopes in the first geographical region 110 may be, for example, but are not limited to, 5 degrees, 10 degrees, 15 degrees, or 20 degrees. In an embodiment, the weather patterns associated with the first geographical region 110 may be indicative of the temperature of the first geographical region 110 for a first period (such as 1 day, 1 week, 3 months, 6 months, or 1 year), a humidity level of the first geographical region 110 for the first time period. In an example embodiment, the temperature of the first geographical region 110 for the first time period may be, for example, but is not limited to, 25 degrees Celsius, 30 degrees Celsius, 35 degrees Celsius, or 40 degrees Celsius. In another example embodiment, the humidity level of the first geographical region 110 for the first time period may be, for example, but is not limited to, 15 percent, 35 percent, 40 percent, or 60 percent.

In an embodiment, the system 102 may be configured to obtain the second set of parameters. The second set of parameters may be associated with at least one of the set of vehicles 104 or the set of charging points 116 within the first geographical region 110. The second set of parameters may be associated with at least one of the mobility patterns of the user of each vehicle of the set of vehicles 104, a destination of each vehicle of the set of vehicles 104, the distance of each charging point of the set of charging points 116 from each vehicle of the set of vehicles 104, the availability of each charging point of the set of charging points 116, or the infrastructure of the first geographical region 110. In an embodiment, the system 102 may be configured to obtain the second set of parameters for the first time period.

In an embodiment, the mobility patterns of the user of each vehicle of the set of vehicles 104 may be indicative of at least one of one or more routes traversed by the set of vehicles 104 during each of the historical driving events within the first geographical region 110, a speed of each vehicle of the set of vehicles 104 during each of the historical driving events, a destination location of each vehicle of the set of vehicles 104 during each of the historical driving events, or duration each of the historical driving events. In an example embodiment, the destination of the first vehicle 104A may correspond to the office of the user of the first vehicle 104A. In an example embodiment, the distance of the first vehicle 104A from the first charging point 116A may be, for example, but is not limited to, 10 miles.

In another embodiment, the availability of each charging point of the set of charging points 116 may correspond to a probability of availability of each charging point of the set of charging points 116 for charging the set of vehicles 104 In an example embodiment, the probability of availability of each charging point of the set of charging points 116 for charging the set of vehicles 104 at the first time period may be, for example, but is not limited to, 40 percent, 65 percent, 80 percent, or 90 percent. In an embodiment, the infrastructure of the first geographical region 110 may include, but is not limited to, road segments (such as the road segment 112), bridges, electrical grid lines, buildings, railways tracks, water supply pipelines, natural gas supply pipelines, or power plants.

In an embodiment, the first accessibility score may be determined based on at least one of the first set of parameters or the second set of parameters. In an example embodiment, the first accessibility score may decrease corresponding to a decrease in the elevation of the first geographical region 110 with respect to the sea level, a decrease in the average steepness of slopes in the first geographical region 110, an increase in the distance of each charging point of the set of charging points 116 from each vehicle of the set of vehicles 104, a decrease in the probability of availability of each charging point of the set of charging points 116 for charging the set of vehicles 104, a presence of flat plains in the terrain of the first geographical region 110, an improvement of the infrastructure (such as the expansion of the electrical lines, an increase in a number of charging points of the set of charging points 116, or a maintenance of the road segment 112) in the first geographical region 110.

In an embodiment, the system 102 may be configured to obtain at least one of the first set of parameters or the second set of parameters from one or more sources associated with the set of vehicles 104 or the first geographical region 110. In an embodiment, the system 102 may be configured to obtain at least one of the first set of parameters or the second set of parameters from each vehicle of the set of vehicles 104. In an embodiment, the system 102 may be configured to obtain the vehicle parameters of the first set of parameters from a first set of sensors associated with the first set of vehicles 104. In another embodiment, the system 102 may be configured to obtain the first set of parameters from the set of charging points 116 and the geographical region parameters of the first set of parameters or the second set of parameters from the mapping database 106B. In an embodiment, the system 102 may be configured to obtain at least one of the first set of parameters or the second set of parameters from a second set of sensors situated proximate to the set of lane segments 114. In an embodiment, the system 102 may be configured to obtain the second set of parameters from one or more websites associated with the infrastructure of the first geographical region 110. In an example embodiment, the one or more websites may be, for example, but are not limited to, government websites (such as a department of transportation), city planner websites, or municipal committee websites associated with the first geographical region 110. In an embodiment, the system 102 may be configured to obtain the infrastructure data from the one or more websites associated with the infrastructure of the first geographical region 110 through web crawling techniques, application programming interface (API) calls, or any other data retrieval techniques known in the art. In an embodiment, the infrastructure data may include, but are not limited to, a number of infrastructure projects, the location of infrastructure projects, the duration to complete the infrastructure projects, and the like.

At 304, an index determination operation may be executed. In the index determination operation, the system 102 may be configured to determine the first index based on the obtained first set of parameters. The first index may be indicative of the consumption of the battery by the set of vehicles 104 in the first geographical region 110. Specifically, the index determination module 202C of the processor 202 may be configured to determine the first index based on the obtained first set of parameters. In an embodiment, the system 102 may be configured to determine the first index based on an application of the second ML model 206B on the obtained first set of parameters. Details about the application of the second ML model 206B for the determination of the first index are provided, for example, in FIG. 7A.

In another embodiment, the system 102 may be configured to determine the first index for the first time period based on the obtained first set of parameters. The first index may be indicative of the consumption of the battery by the set of vehicles 104 in the first geographical region 110 for the first time period.

In an embodiment, the system 102 may be configured to determine a set of values associated with the consumption of the battery by the set of vehicles 104 corresponding to operations of the set of vehicles 104 on the slopes (such as uphill or downhill) in the first geographical region 110. In an example embodiment, the first value of the set of values may correspond to the amount of voltage utilized by the first vehicle 104A for the operations on the slopes in the first geographical region 110. In another embodiment, the system 102 may be configured to determine a set of historical values associated with a historical consumption of the battery by the set of vehicles 104 in the first geographical region 110. In an example embodiment, a first historical value of the set of historical values may correspond to a historical amount of voltage utilized by the first vehicle 104A during the historical driving events in the first geographical region 110. Further, the system 102 may be configured to determine the first index based on the set of values and the set of historical values. The first index may be indicative of the consumption of the battery by the set of vehicles 104 in the first geographical region 110. In yet another embodiment, the system 102 may be configured to output a heatmap indicative of the consumption of the battery by the set of vehicles 104 in the first geographical region 110. In an embodiment, the heatmap may correspond to a graphical representation of the consumption of the battery by the set of vehicles 104 in the first geographical region 110. In an embodiment, the heatmap may indicate the consumption of the battery with a color gradient. Further, the color gradient may include darker colors or lighter colors. The darker color may be indicative of high consumption of the battery by the set of vehicles 104 in the first geographical region 110. Further, the lighter colors may be indicative of low consumption of the battery by the set of vehicles 104 in the geographical region 110.

In an embodiment, the system 102 may be further configured to determine the second index based on the obtained second set of parameters. The second index may be indicative of the utilization of at least one of the set of vehicles 104 or the set of charging points 116 within the first geographical region 110. Specifically, the index determination module 202C may be configured to determine the second index based on the obtained second set of parameters. In an embodiment, the system 102 may be configured to determine the second index based on an application of the second ML model 206B on the obtained second set of parameters. Details about the application of the second ML model 206B for the determination of the second index are provided, for example, in FIG. 7B. In another embodiment, the system 102 may be configured to determine the second index for the first time period based on the obtained second set of parameters. The second index may be indicative of the utilization of at least one of the set of vehicles 104 or the set of charging points 116 within the first geographical region 110 for the first time period.

At 306, an accessibility score determination operation may be executed. In the accessibility score determination operation, the system 102 may be configured to determine the first accessibility score based on the first index and the second index. The first accessibility score may be indicative of the accessibility of the usage of the set of vehicles 104 in the first geographical region 110. Specifically, the score determination module of the processor 202 may be configured to determine the first accessibility score based on the determined first index and the determined second index. In another embodiment, the system 102 may be configured to determine the first accessibility score for the first time period based on the obtained first index and the obtained second index. The first accessibility score may be indicative of the accessibility of the usage of the set of vehicles 104 in the first geographical region 110 for the first time period.

In an embodiment, the system 102 may be configured to determine a consumption score based on a first correlation of the first index with a consumption factor. The system 102 may be further configured to determine a utilization score based on a second correlation of the second index with a utilization factor. Thereafter, the system 102 may be further configured to determine the first accessibility score based on a third correlation of the consumption score with the utilization score.

In another embodiment, the system 102 may be further configured to obtain a set of tiles associated with the first geographical region 110 from the mapping database 106B. Each tile of the set of tiles may be indicative of at least one portion of the first geographical region 110. Each tile of the set of tiles may represent at least a portion of the first geographical region 110 at a different resolution. In an embodiment, the mapping database 106B may determine resolution levels for the set of tiles based on increasing resolution levels with resolution at level 0 being the lowest. In an example embodiment, the lowest resolution level (e.g., level 0) may be represented by a fixed resolution (e.g., 512×512 pixels). Then at each increasing resolution level, the map resolution may be doubled so that the resolution at level 1 increases to 1024×1024 pixels, the resolution at level 2 increases to 2048, and so on. Based on the first set of parameters for the corresponding tile of the set of tiles, the system 102 may be configured to determine a first set of indexes. The first set of indexes may be indicative of the consumption of the battery by the set of vehicles 104 in each tile of the set of tiles. Based on the second set of parameters for the corresponding tile of the set of tiles, the system 102 may be further configured to determine a second set of indexes. The set of indexes may be indicative of the utilization of at least one of the set of vehicles 104 or the set of charging points 116 in each tile of the set of tiles. Based on the first set of indexes and the second set of indexes, the system 102 may be configured to determine a set of accessibility scores. The set of accessibility scores may be indicative of the accessibility of the usage of the set of vehicles 104 in each tile of the set of tiles. Thereafter, based on the determined set of accessibility scores, the system 102 may be configured to determine the first accessibility score. The first accessibility score may be indicative of the accessibility of the usage of the set of vehicles 104 in the first geographical region 110. In an embodiment, the system 102 may be configured to determine the first accessibility score based on an average (or a mean) of the determined set of accessibility scores. In another embodiment, the system 102 may be configured to determine the first accessibility score based on a maximum of the determined set of accessibility scores.

In an embodiment, the system may be configured to determine a charging point distance score based on the distance between the first vehicle 104A, and the first charging point 116A for a current time. Further, the first distance of the first charging point 116A from the first vehicle 104A is less than the distance of each of the set of charging points 116A. In an embodiment, the charging point distance score may be indicative of closeness of the first charging point 116A from the first vehicle 104A. In an embodiment, the system 102 may be configured to determine the first accessibility score based on the first index, the second index, and the charging point distance score.

At 308, an accessibility score output operation may be executed. In the accessibility score output operation, the system 102 may be configured to output the determined first accessibility score. Specifically, the output module 202E of the processor 202 may be configured to output the determined first accessibility score. In an embodiment, the processor 202 may be configured to output the determined first accessibility score for at least one user associated with the determination of the first accessibility score for the first geographical region 110. In an embodiment, the determination of the first accessibility score may allow the users of the set of vehicles 104 to determine whether it is convenient to travel in the first geographical region 110 by using the set of vehicles 104, thereby increasing a user experience of the users of the set of vehicles 104. In an embodiment, the output of the determined first accessibility score may correspond to a rendering of the first accessibility score on a user interface associated with each vehicle of the set of vehicles 104 or a user device associated with each vehicle of the set of vehicles 104.

In an embodiment, the user device may be, for example, but is not limited to, a client device, such as a thin client device, a mobile device, a mainframe computer, a desktop computer, and the like. In an embodiment, the first accessibility score may be displayed on a display screen associated with the infotainment system of each vehicle of the set of vehicles 104 or the user device (such as a mobile phone). In another example, the user associated with each vehicle of the set of vehicles 104 may be notified by using an audio signal, thereby rendering the first accessibility score via a set of speakers associated with the infotainment system or the user device.

In another embodiment, the determination of the first accessibility score may allow the city planners, the municipalities workers, the government, and the like to determine a need for improvement in the infrastructure (such as the charging points, the roads, and the like) associated with the geographical region. In yet another embodiment, the determination of the accessibility score may allow the users of the set of vehicles 104 to determine their future accommodations or travel plans in the first geographical region 110. In yet another embodiment, the determination of the accessibility score may allow the real estate companies to identify the first geographical region 110 as a potential geographical region for real estate projects.

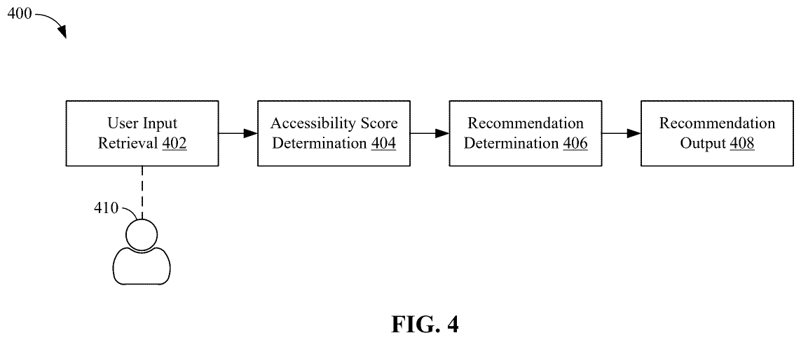

FIG. 4 is a block diagram 400 that illustrates an exemplary second set of operations for recommendation based on the accessibility of the usage of vehicles in the geographical region, in accordance with an embodiment of the disclosure. FIG. 4 is explained in conjunction with elements from FIGS. 1, 2, and 3. With reference to FIG. 4, there is shown the block diagram 400 that illustrates exemplary operations from 402 to 408, as described herein. The exemplary operations illustrated in the block diagram 400 may start at 402 and may be performed by any computing system, apparatus, or device, such as by the system 102 of FIG. 1 or the processor 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, a user input reception operation may be executed. In the user input retrieval operation, the system 102 may be configured to receive a user input associated with the determination of the first accessibility score for the first geographical region 110. In an embodiment, the user 410 of the first vehicle 104A may provide the user input associated with a destination of the first vehicle 104A of the set of vehicles 104. Further, the destination of the first vehicle 104A is in the first geographical region 110. In an embodiment, the user 410 of the first vehicle 104A may provide the user input to navigate in the first geographical region 110 using the first vehicle 104A. In another embodiment, the user 410 of the first vehicle 104A may provide the user input to determine their future accommodations or travel plans in the first geographical region 110.

In an embodiment, the processor 202 may be configured to provide the destination of the first vehicle 104A as an option for selection by the user 410 of the first vehicle 104A. The user input may correspond to, but is not limited to, a touch input, a tactile input, an audio input, or a gesture. In an embodiment, the destination of the first vehicle 104A may be displayed on the display screen associated with the infotainment system of the first vehicle 104A or the user device (such as the mobile phone) associated with the user 410 of the first vehicle 104A. In another example, the user 410 may be notified by using an audio signal, thereby rendering the destination of the first vehicle 104A via a set of speakers associated with the infotainment system of the first vehicle 104A or the user device of the first vehicle 104A.

At 404, an accessibility score determination operation may be executed. In the accessibility score determination operation, the system 102 may be configured to determine the first accessibility score based on the first user input. The first accessibility score may be indicative of the accessibility of the usage of the set of vehicles 104 in the first geographical region 110. Specifically, the score determination module of the processor 202 may be configured to determine the first accessibility score based on the reception of the first user input. Details about the determination of the first accessibility score are provided, for example, at 306 in FIG. 3.

At 406, a recommendation determination operation may be executed. In the recommendation determination operation, the system 102 may be configured to determine the recommendation based on the first user input. In an embodiment, the processor 202 may be configured to determine the recommendation based on the reception of the first user input. In an embodiment, the recommendation may include, but is not limited to, a set of routes to reach the destination of the first vehicle 104A in the first geographical region 110, and a respective accessibility score for each of the set of routes. In another embodiment, the recommendation may include a set of accommodations situated in the first geographical region 110.

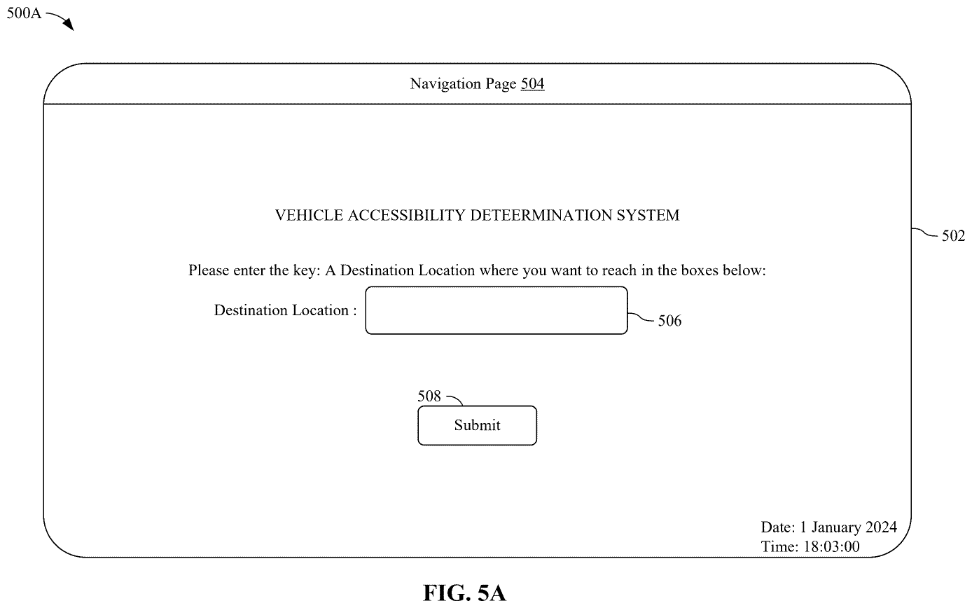

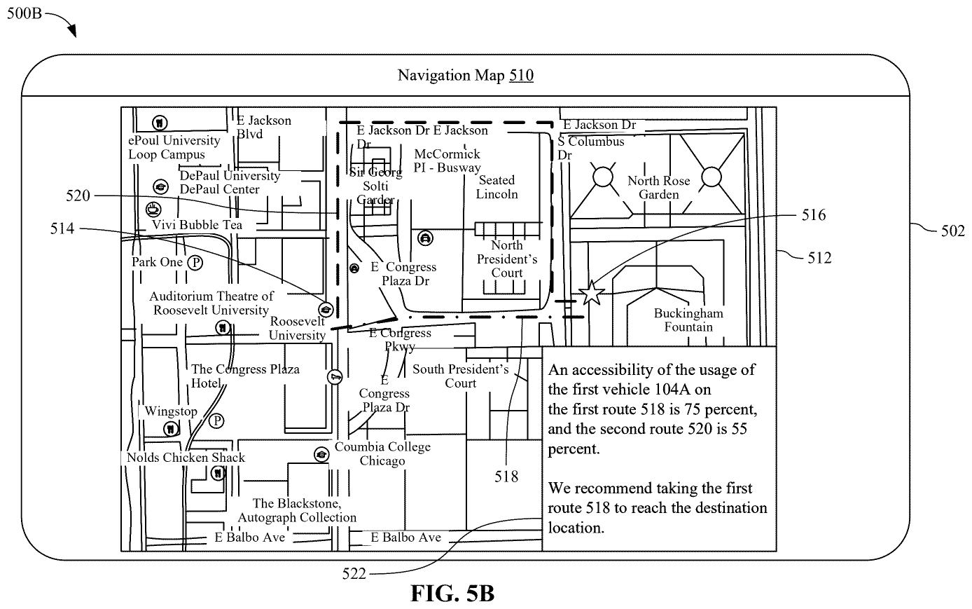

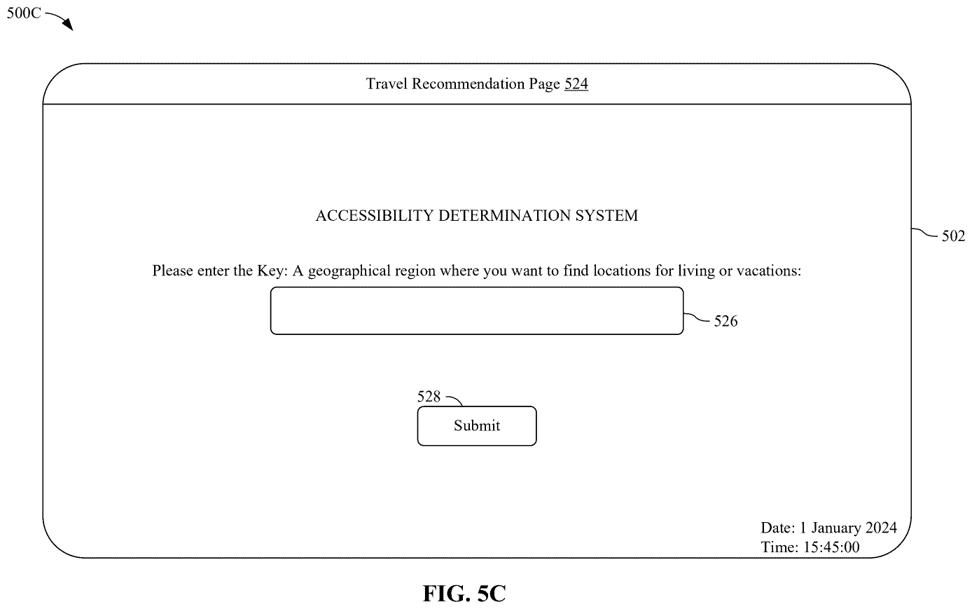

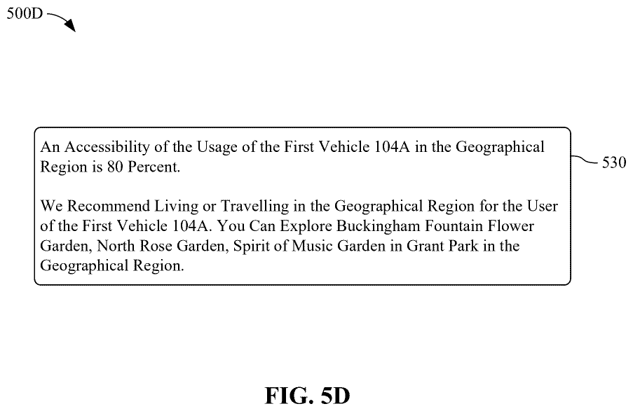

At 410, a recommendation output operation may be executed. In the recommendation output operation, the system 102 may be configured to output the determined recommendation. Specifically, the output module 202E of the processor 202 may be configured to output the determined recommendation. In an embodiment, the output of the determined recommendation may correspond to a rendering of the determined recommendation on a user interface associated with each vehicle of the set of vehicles 104 or a user device associated with each vehicle of the set of vehicles 104. Details about the recommendation are provided, for example, in FIGS. 5A, 5B, 5C, and 5D.

In an embodiment, based on the determined recommendation, the system 102 may be configured to generate one or more navigation instructions to navigate the first vehicle 104A toward the destination. Further, based on the one or more navigation instructions, the system 102 may be configured to control the first vehicle 104A to navigate towards the destination.

FIGS. 5A, and 5B are first exemplary diagrams 500A and 500B that collectively depict user interface associated with the operations for the determination of the recommendation based on the accessibility of the usage of the vehicles in the geographical region, in accordance with an embodiment of the disclosure. FIGS. 5A, and 5B are explained in conjunction with FIG. 1, FIG. 2, FIG. 3, and FIG. 4.

In an embodiment, the system 102 may be configured to obtain the first input from the user 410 of the first vehicle 104A. In an embodiment, the user 410 may input the first input via an electronic device 502 associated with the first vehicle 104A. The electronic device 502 may include a display screen that may be configured to render a navigation page 504 to the user 410. In an embodiment, the navigation page 504 may be associated with a vehicle accessibility determination system (such as the system 102). In an embodiment, the navigation page 504 may display a prompt “Please Enter the Destination Location in the below box:”. Further, the user 410 may enter the first input in an input box 506. In an embodiment, the first input may include at least a destination location of the first vehicle 104A. As an example and not limitation, the first input may correspond to “Buckingham Fountain Flower Garden”.

In an embodiment, the navigation page 504 may further include a submit field 508. The submit field 508 may be configured to receive a second input from the user 410. In an embodiment, the submit field 508 may be referred to as the “submit” button. The navigation page 504 may further display a current date and a current time. In an example embodiment, the current date corresponds to “1 Jan. 2024”, and the current time corresponds to “18:03:00”.

In an embodiment, based on the reception of the second input from the user 410, the electronic device 502 may be configured to display a navigation map 510 of a geographical region 512. In an embodiment, the system 102 may be configured to receive the second input to select the submit field 508. The second input corresponds to, but is not limited to, the touch input, the tactile input, the audio input, or the gesture. The navigation map 510 may include a source location 514 (such as Roosevelt University), a destination location 516 (such as Buckingham Fountain Flower Garden), a first route 518 from the source location 514 to the destination location 516, a second route 520 from the source location 514 to the destination location 516, and a recommendation 522 associated with the accessibility of the usage of the first vehicle 104A in the geographical region 512. In an embodiment, based on the second user input, the system 102 may be configured to determine an accessibility score for the geographical region 512. Details about the determination of the accessibility score are provided, for example, in FIG. 3. Further, based on the accessibility score, the system 102 may be configured to determine the recommendation 522 associated with the accessibility of the usage of the first vehicle 104A in the geographical region 512. By way of an example and not limitation, the recommendation 522 may correspond to “an accessibility of the usage of the first vehicle 104A on the first route 518 is 75 percent, and the second route 520 is 55 percent. We recommend taking the first route to reach the destination location 516.”

In an embodiment, the system 102 may be configured to determine at least one of a view of the navigation map 510, a zoom level of the navigation map 510, or a framing of the navigation map 510. In an embodiment, the system 102 may be configured to display the navigation map 510 and at least one parameter associated with the determination of the accessibility score for the geographical region 512. In an example embodiment, the at least one parameter may be, for example, but is not limited to, at least one parameter of the first set of parameters or at least one parameter of the second set of parameters. In an embodiment, the system 102 may be configured to determine the accessibility score for the first time period (such as in the morning or evening). Further, the system 102 may be configured to display the determined accessibility score for the first time period.

FIGS. 5C, and 5D are first exemplary diagrams 500C and 500D that collectively depict user interface associated with the operations for the determination of the recommendation based on the accessibility of the usage of the vehicles in the geographical region, in accordance with an embodiment of the disclosure. FIG. 5C, and FIG. 5D are explained in conjunction with FIG. 1, FIG. 2, FIG. 3, FIG. 4, FIG. 5A, and FIG. 5B.

In an embodiment, the display screen of the electronic device 502 may be further configured to render an accommodation recommendation page 524 to the user 410. In an embodiment, the accommodation recommendation page 524 may be associated with the vehicle accessibility determination system (such as the system 102). In an embodiment, the accommodation recommendation page 524 may display a prompt “A geographical region where you want to find locations for living or vacations:” Further, the user 410 may enter the first input in an input box 526. In an embodiment, the first input may include at least the destination location of the first vehicle 104A. In an exemplary embodiment, the first input may correspond to “Chicago, USA”.

In an embodiment, the accommodation recommendation page 524 may further include a submit field 528. The submit field 528 may be configured to receive a third input from the user 410. In an embodiment, the submit field 528 may be referred to as the “submit button”. In an embodiment, the system 102 may be configured to receive the third input to select the submit field 528. The third input corresponds to, but is not limited to, the touch input, the tactile input, the audio input, or the gesture. The accommodation recommendation page 524 may further display the current date and the current time. In an example embodiment, the current date corresponds to “1 Jan. 2024”, and the current time corresponds to “18:03:00”.

In an embodiment, based on the reception of the third user input from the user 410, the system 102 may be configured to determine the accessibility score for the geographical region 512. Further, based on the accessibility score, the system 102 may be configured to determine the recommendation 530 associated with the locations for living or vacations. By way of an example and not limitation, the recommendation 530 may correspond to “An accessibility of the usage of the first vehicle 104A in the geographical region is 80 percent. We recommend living or traveling in the geographical region for the user of the first vehicle 104A. You can explore Buckingham Fountain Flower Garden, North Rose Garden, and Spirit of Music Garden in Grant Park in the geographical region.”

FIG. 6 is a diagram depicting training 602 of the first ML model 206A for the determination of the second accessibility score, in accordance with an embodiment of the disclosure. As shown, there is a training portion above line 600 and an implementation portion below line 600. In the training portion above line 600, the system 102 may be configured to generate a historical training dataset 610 for the training 602 of the first ML model 206A. The historical training dataset 610 may be associated with the first geographical region 110. In an embodiment, the system 102 may be configured to generate the historical training dataset 610 based on a first set of parameters 604, a second set of parameters 606, and a first accessibility score 608. The first set of parameters 604 may be associated with the consumption of the battery by the set of vehicles 104 in the first geographical region 110. The second set of parameters 606 may be associated with at least one of the set of vehicles 104 or the set of charging points 116 within the first geographical region 110. The first accessibility score may be indicative of the accessibility of the usage of the set of vehicles 104 in the first geographical region 110. Details about the first set of parameters 604, the second set of parameters 606, and the first accessibility score 608 are provided, for example, in FIG. 3.

As described in FIG. 2, the first ML model 206A is trained to determine the second accessibility score for the second geographical region. In an embodiment, the system 102 may be configured to train the first ML model 206A to determine the second accessibility score for the second geographical region using input data (a third set of parameters associated with the consumption of the battery by the set of vehicles 104, a fourth set of parameters associated with the at least one of the set of vehicles 104 or the set of charging points 116 within the second geographical region) and the historical training dataset associated with the first geographical region 110. In an embodiment, the first ML model 206A may be trained to determine the second accessibility score with the historical training dataset. In an embodiment, the first ML model 206A may be trained to determine the second accessibility score as a function of the historical training dataset and the input data. In an embodiment, the first ML model 206A may be trained using batches of the historical training dataset data or the input data. In an embodiment, the first ML model 206A may be trained to adjust a prediction of the second accessibility score with the historical training dataset 610.

In the implementation portion below line 600, at 612, a third set of parameters acquisition operation may be executed. In the data acquisition operation, the system 102 may be configured to obtain a third set of parameters. The third set of parameters may be associated with the consumption of the battery by the set of vehicles 104 in the second geographical region. Specifically, the input module 202A of the processor 202 may be configured to obtain the third set of parameters. The third set of parameters may include at least one of the vehicle parameters associated with each vehicle of the set of vehicles 104, or another geographical region parameters associated with the second geographical region.

At 614, a fourth set of parameters acquisition operation may be executed. In the data acquisition operation, the system 102 may be configured to obtain a fourth set of parameters. The fourth set of parameters may be associated with at least one of the set of vehicles 104 or the set of charging points 116 within the second geographical region. Specifically, the input module 202A of the processor 202 may be configured to obtain the fourth set of parameters. The fourth set of parameters may be associated with at least one of the mobility patterns of the user of each vehicle of the set of vehicles 104 in the second geographical region, a destination of each vehicle of the set of vehicles 104 in the second geographical region, a distance of each charging point of the set of charging points 116 from each vehicle of the set of vehicles 104, an availability of each charging point of the set of charging points 116, or an infrastructure of the second geographical region.

At 616, a first ML model application operation may be executed. In the first ML model application operation, the system 102 may be configured to apply the trained first ML model 206A on the third set of parameters and the fourth set of parameters. Specifically, the ML application module 202B of the processor 202 may be configured to apply the trained first ML model 206A on the third set of parameters and the fourth set of parameters.

At 618, a second accessibility score determination operation may be executed. In the second accessibility score determination operation, the system 102 may be configured to determine the second accessibility score based on the output of the second ML model 206B. The second accessibility score may be indicative of the accessibility of the usage of the set of vehicles 104 in the second geographical region.

FIG. 7A is a diagram depicting training 702 of the second ML model 206B for the determination of the first index, in accordance with an embodiment of the disclosure. As shown, there is a training portion above line 700A and an implementation portion below line 700A. In the training portion above line 700A, the system 102 may be configured to generate a training dataset 706 for the training 702 of the second ML model 206B. In an embodiment, the system 102 may be configured to train the second ML model 206B to determine the first index. The first index may be indicative of the consumption of the battery by the set of vehicles 104 in the first geographical region 110. In an embodiment, the system 102 may be configured to generate the training dataset 706 based on at least a training consumption score 704. The training consumption score 704 may be indicative of a historical consumption of the battery of the set of vehicles 104 in a third geographical region. In an embodiment, the third geographical region may be situated proximate to the first geographical region 110. In an embodiment, the second ML model 206B may be trained to determine the first index as a function of the training consumption score 704 and the first set of parameters. In an embodiment, the first ML model 206A may be trained using batches of the training consumption score 704 and the first set of parameters 604. In an embodiment, the first ML model 206A may be trained to adjust a prediction of the first index with the training dataset 702.

In the implementation portion below line 700A, at 708, a first set of parameters operation may be executed. In the first set of parameters operation, the system 102 may be configured to obtain the first set of parameters 604. The first set of parameters 604 may be associated with the consumption of the battery by the set of vehicles 104 in the first geographical region 110. Specifically, the input module 202A of the processor 202 may be configured to obtain the first set of parameters 604. The first set of parameters 604 may include at least one of the vehicle parameters associated with each vehicle of the set of vehicles 104, or the geographical region parameters associated with the first geographical region 110. Details about the acquisition of the first set of parameters 604 are provided, for example, in FIG. 2 and FIG. 3 (at 302).

At 710, a second ML model application operation may be executed. In the second ML application operation, the system 102 may be configured to apply the second ML model 206B on the first set of parameters 604. Specifically, the ML application module 202B may be configured to apply the second ML model 206B on the first set of parameters 604.

At 712, a first index determination operation may be executed. In the first index determination operation, the system 102 may be configured to determine the first index based on an application of the second ML model 206B on the obtained first set of parameters 604. The first index may be indicative of the consumption of the battery by the set of vehicles 104 in the first geographical region 110.

FIG. 7B is a diagram depicting training 714 of the second ML model 206B for the determination of the second index, in accordance with an embodiment of the disclosure. As shown, there is a training portion above line 700B and an implementation portion below line 700B. In the training portion above line 700B, the system 102 may be configured to generate a training dataset 706 for the training 718 of the second ML model 206B. In an embodiment, the system 102 may be configured to train the second ML model 206B to determine the second index. The second index may be indicative of a utilization of at least one of the set of vehicles 104 or the set of charging points 116 within the first geographical region 110. In an embodiment, the system 102 may be configured to generate the training dataset 718 based on at least a training utilization score 716. The training utilization score 716 may be indicative of a historical utilization of at least one of the set of vehicles 104 or the set of charging points 116 in the third geographical region. In an embodiment, the third geographical region may be situated proximate to the first geographical region 110. In an embodiment, the second ML model 206B may be trained to determine the second index as a function of the training utilization score 716 and the second set of parameters 606. In an embodiment, the second ML model 206B may be trained using batches of the training utilization score 716 and the second set of parameters 606. In an embodiment, the second ML model 206B may be trained to adjust a prediction of the second index with the training dataset 718.

In the implementation portion below line 700B, at 720, a second set of parameters acquisition operation may be executed. In the second set of parameters acquisition operation, the system 102 may be configured to obtain the second set of parameters 606. The second set of parameters 606 may be associated with at least one of the set of vehicles 104 or the set of charging points 116 within the first geographical region 110. The second set of parameters 606 may be associated with at least one of the mobility patterns of the user of each vehicle of the set of vehicles 104, the destination of each vehicle of the set of vehicles 104, the distance of each charging point of the set of charging points 116 from each vehicle of the set of vehicles 104, the availability of each charging point of the set of charging points 116, or the infrastructure of the first geographical region 110. Details about the acquisition of the second set of parameters 606 are provided, for example, in FIG. 2 and FIG. 3 (at 302).

At 722, a second ML model application operation may be executed. In the second ML application operation, the system 102 may be configured to apply the second ML model 206B on the second set of parameters 604. Specifically, the ML application module 202B may be configured to apply the second ML model 206B on the second set of parameters 604.

At 712, a second index determination operation may be executed. In the second index determination operation, the system 102 may be configured to determine the second index based on the application of the second ML model 206B on the obtained second set of parameters 606. The second index may be indicative of the utilization of at least one of the set of vehicles 104 or the set of charging points 116 within the first geographical region 110.

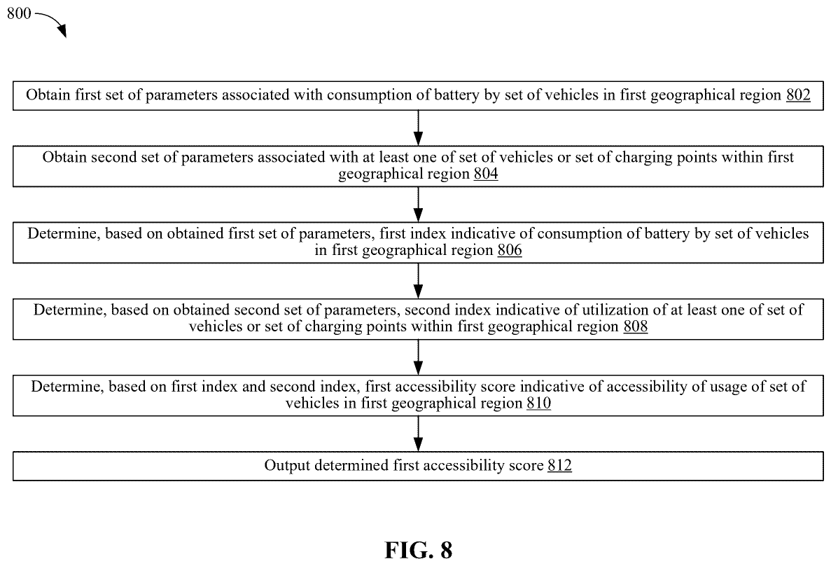

FIG. 8 is a flowchart 800 that illustrates a first exemplary method for determination of the accessibility of the usage of the vehicles in the geographical region, in accordance with an embodiment of the disclosure. FIG. 8 is explained in conjunction with elements from FIGS. 1, 2, 3, 4, 5A,5B, 5C, 5D, 6, and 7A, and 7B. With reference to FIG. 8, there is shown the flowchart 800. The operations of the first exemplary method may be executed by any computing system, for example, by the system 102 of FIG. 1 or the processor 202 of FIG. 2. The operations of the flowchart 800 may start at 802.

At 802, the first set of parameters associated with the consumption of battery by the set of vehicles 104 in the first geographical region 110 may be obtained. In an embodiment, the system 102 may be configured to obtain the first set of parameters associated with the consumption of battery by the set of vehicles 104 in the first geographical region 110. In at least one embodiment, the processor 202 may be configured to obtain the first set of parameters associated with the consumption of battery by the set of vehicles 104 in the first geographical region 110. Details about the acquisition of the first set of parameters are provided, for example, in FIGS. 1 and 3 (at 302).

At 804, the second set of parameters associated with at least one of the set of vehicles 104 or the set of charging points 116 within the first geographical region 110 may be obtained. In an embodiment, the system 102 may be configured to obtain the second set of parameters associated with at least one of the set of vehicles 104 or the set of charging points 116 within the first geographical region 110. In at least one embodiment, the processor 202 may be configured to obtain the second set of parameters associated with at least one of the set of vehicles 104 or the set of charging points 116 within the first geographical region 110. Details about the acquisition of the second set of parameters are provided, for example, in FIGS. 1 and 3 (at 302).

At 806, the first index indicative of the consumption of the battery by the set of vehicles 104 in the first geographical region 110 is determined based on the obtained first set of parameters. In an embodiment, the system 102 may be configured to determine the first index based on the obtained first set of parameters. The first index may be indicative of the consumption of the battery by the set of vehicles 104 in the first geographical region 110. In at least one embodiment, the processor 202 may be configured to determine the first index based on the obtained first set of parameters. The first index may be indicative of the consumption of the battery by the set of vehicles 104 in the first geographical region 110. Details about the determination of the first index are provided, for example, in FIGS. 1 and 3 (at 304).

At 808, the second index indicative of utilization of at least one of the set of vehicles 104 or the set of charging points 116 within the first geographical region 110 may be determined based on the obtained second set of parameters. In an embodiment, the system 102 may be configured to determine the second index based on the obtained second set of parameters. The second index may be indicative of the utilization of at least one of the set of vehicles 104 or the set of charging points 116 within the first geographical region 110. In at least one embodiment, the processor 202 may be configured to determine the second index based on the obtained second set of parameters. The second index may be indicative of the utilization of at least one of the set of vehicles 104 or the set of charging points 116 within the first geographical region 110. Details about the determination of the second index are provided, for example, in FIGS. 1 and 3 (at 304).

At 810, the first accessibility score indicative of the accessibility of the usage of the set of vehicles 104 in the first geographical region 110 may be determined based on the first index and the second index. In an embodiment, the system 102 may be configured to determine the first accessibility score based on the first index and the second index. The first accessibility score may be indicative of the accessibility of the usage of the set of vehicles 104 in the first geographical region 110. In at least one embodiment, the processor 202 may be configured to determine the first accessibility score based on the first index and the second index. The first accessibility score may be indicative of the accessibility of the usage of the set of vehicles 104 in the first geographical region 110. Details about the determination of the first accessibility score are provided, for example, in FIGS. 1 and 3 (at 306).

At 812, the determined first accessibility score may be output. In an embodiment, the system 102 may be configured to output the determined first accessibility score. In at least one embodiment, the processor 202 may be configured to output the determined first accessibility score. Details about the outputting of the determined first accessibility score are provided, for example, in FIG. 3 (at 308). Control may pass to the end.

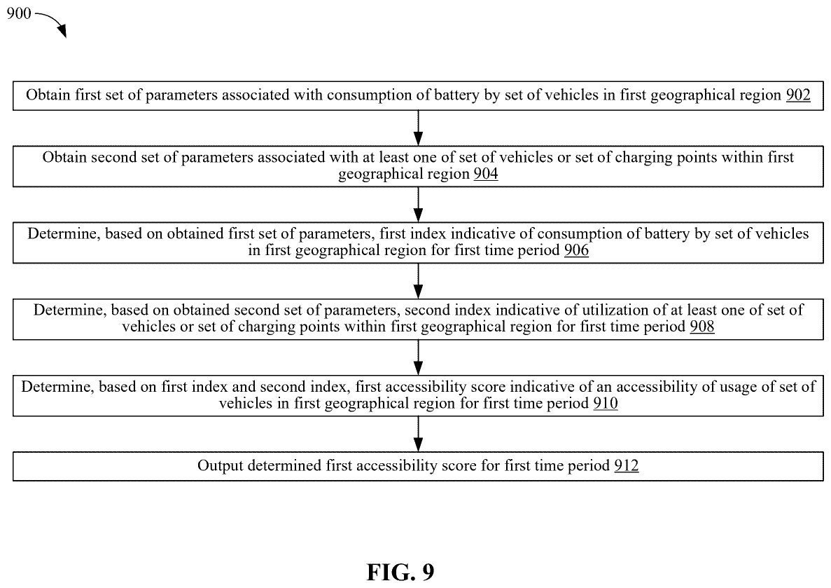

FIG. 9 is a flowchart 900 that illustrates a second exemplary method for determination of the accessibility of the usage of the vehicles in the geographical region, in accordance with an embodiment of the disclosure. FIG. 11 is explained in conjunction with elements from FIGS. 1, 2, 3, 4, 5A, 5B, 5C, 5D, 6, 7A, 7B, and 8. With reference to FIG. 9, there is shown the flowchart 900. The operations of the second exemplary method may be executed by any computing system, for example, by the system 102 of FIG. 1 or the processor 202 of FIG. 2. The operations of the flowchart 900 may start at 902.

At 902, the first set of parameters associated with the consumption of battery by the set of vehicles 104 in the first geographical region 110 may be obtained. In an embodiment, the system 102 may be configured to obtain the first set of parameters associated with the consumption of battery by the set of vehicles 104 in the first geographical region 110. In at least one embodiment, the processor 202 may be configured to obtain the first set of parameters associated with the consumption of battery by the set of vehicles 104 in the first geographical region 110. Details about the acquisition of the first set of parameters are provided, for example, in FIGS. 1 and 3 (at 302).

At 904, the second set of parameters associated with at least one of the set of vehicles 104 or the set of charging points 116 within the first geographical region 110 may be obtained. In an embodiment, the system 102 may be configured to obtain the second set of parameters associated with at least one of the set of vehicles 104 or the set of charging points 116 within the first geographical region 110. In at least one embodiment, the processor 202 may be configured to obtain the second set of parameters associated with at least one of the set of vehicles 104 or the set of charging points 116 within the first geographical region 110. Details about the acquisition of the second set of parameters are provided, for example, in FIGS. 1 and 3 (at 302).

At 906, the first index indicative of the consumption of the battery by the set of vehicles 104 in the first geographical region 110 for the first time period is determined based on the obtained first set of parameters. In an embodiment, the system 102 may be configured to determine the first index based on the obtained first set of parameters. The first index may be indicative of the consumption of the battery by the set of vehicles 104 in the first geographical region 110 for the first time period. In at least one embodiment, the processor 202 may be configured to determine the first index based on the obtained first set of parameters. The first index may be indicative of the consumption of the battery by the set of vehicles 104 in the first geographical region 110 for the first time period. Details about the determination of the first index are provided, for example, in FIGS. 1 and 3 (at 304).

At 908, the second index indicative of utilization of at least one of the set of vehicles 104 or the set of charging points 116 within the first geographical region 110 for the first time period may be determined based on the obtained second set of parameters. In an embodiment, the system 102 may be configured to determine the second index based on the obtained second set of parameters. The second index may be indicative of the utilization of at least one of the set of vehicles 104 or the set of charging points 116 within the first geographical region 110 for the first time period. In at least one embodiment, the processor 202 may be configured to determine the second index based on the obtained second set of parameters. The second index may be indicative of the utilization of at least one of the set of vehicles 104 or the set of charging points 116 within the first geographical region 110 for the first time period. Details about the determination of the second index are provided, for example, in FIGS. 1 and 3 (at 304).

At 910, the first accessibility score indicative of the accessibility of the usage of the set of vehicles 104 in the first geographical region 110 for the first time period may be determined based on the first index and the second index. In an embodiment, the system 102 may be configured to determine the first accessibility score based on the first index and the second index. The first accessibility score may be indicative of the accessibility of the usage of the set of vehicles 104 in the first geographical region 110 for the first time period. In at least one embodiment the processor 202 may be configured to determine the first accessibility score based on the first index and the second index. The first accessibility score may be indicative of the accessibility of the usage of the set of vehicles 104 in the first geographical region 110 for the first time period. Details about the determination of the first accessibility score are provided, for example, in FIGS. 1 and 3 (at 306).

At 912, the determined first accessibility score for the first time period may be output. In an embodiment, the system 102 may be configured to output the determined first accessibility score for the first time period. In at least one embodiment, the processor 202 may be configured to output the determined first accessibility score for the first time period. Details about the outputting of the determined first accessibility score are provided, for example, in FIG. 3 (at 308). Control may pass to the end.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system, comprising:
a memory to store computer-executable instructions; and
one or more processors coupled to the memory, wherein the one or more processors are configured to:
obtain a first set of parameters associated with a consumption of a battery by a set of vehicles in a first geographical region;
obtain a second set of parameters associated with at least one of the set of vehicles or a set of charging points within the first geographical region;
determine, based on the obtained first set of parameters, a first index indicative of the consumption of the battery by the set of vehicles in the first geographical region;
determine, based on the obtained second set of parameters, a second index indicative of a utilization of at least one of the set of vehicles or the set of charging points within the first geographical region;
determine, based on the first index and the second index, a first accessibility score indicative of an accessibility of a usage of the set of vehicles in the first geographical region; and
output the determined first accessibility score.

2. The system of claim 1, wherein the first set of parameters comprises at least one of vehicle parameters associated with each vehicle of the set of vehicles, or geographical region parameters associated with the first geographical region.

3. The system of claim 2, wherein the vehicle parameters are associated with at least one of a weight of each vehicle of the set of vehicles, a speed of each vehicle of the set of vehicles, a tire-size of each vehicle of the set of vehicles, an aerodynamic drag of each vehicle of the set of vehicles, an idling state of each vehicle of the set of vehicles, a battery size of each vehicle of the set of vehicles, a battery capacity of each vehicle of the set of vehicles, or a battery consumption rate of each vehicle of the set of vehicles.

4. The system of claim 1, wherein the second set of parameters is associated with at least one of mobility patterns of a user of each vehicle of the set of vehicles, destination of each vehicle of the set of vehicles, a distance of each charging point of the set of charging points from each vehicle of the set of vehicles, an availability of each charging point of the set of charging points, or an infrastructure of the first geographical region.

5. The system of claim 1, wherein the one or more processors are configured to:
receive a first user input associated with a destination of a first vehicle of the set of vehicles, wherein the destination of the first vehicle is in the first geographical region;
determine, based on the first user input, the first accessibility score for the first geographical region;
determine a recommendation based on the first accessibility score; and
output the determined recommendation.

6. The system of claim 5, wherein the one or more processors are further configured to:
generate, based on the determined recommendation, one or more navigation instructions to navigate the first vehicle towards the destination; and
control, based on the one or more navigation instructions, the first vehicle to navigate towards the destination.

7. The system of claim 1, wherein the one or more processors are further configured to:
determine a consumption score based on a first correlation of the first index with a consumption factor;
determine a utilization score based on a second correlation of the second index with a utilization factor; and
determine the first accessibility score based on a third correlation of the consumption score with the utilization score.

8. The system of claim 1, wherein the one or more processors are further configured to:
obtain, using a map database, a set of tiles associated with the first geographical region, wherein each tile of the set of tiles is indicative of at least one portion of the first geographical region;
determine, based on the first set of parameters for the corresponding tile of the set of tiles, a first set of indexes indicative of the consumption of the battery by the set of vehicles in each tile of the set of tiles;
determine, based on the second set of parameters for the corresponding tile of the set of tiles, a second set of indexes indicative of the utilization of at least one of the set of vehicles or the set of charging points in each tile of the set of tiles;
determine, based on the first set of indexes and the second set of indexes, a set of accessibility scores indicative of the accessibility of the usage of the set of vehicles in each tile of the set of tiles; and
determine the first accessibility score indicative of the accessibility of the usage of the set of vehicles in the first geographical region based on the determined set of accessibility scores.

9. The system of claim 1, wherein the one or more processors are further configured to:
generate a training dataset based on the obtained first set of parameters, the obtained second set of parameters, and the determined first accessibility score, and
train a first machine learning (ML) model based on the generated training dataset, wherein the first ML model is trained to determine an accessibility score for a geographical region.

10. The system of claim 9, wherein the one or more processors are further configured to:
obtain a third set of parameters associated with the consumption of the battery by the set of vehicles in a second geographical region;
obtain a fourth set of parameters associated with at least one of the set of vehicles or the set of charging points within the second geographical region;
apply the trained first ML model on the third set of parameters and the fourth set of parameters;
determine, based on an output of the first ML model, a second accessibility score indicative of the accessibility of the usage of the set of vehicles in the second geographical region; and
output the determined second accessibility score.

11. The system of claim 1, wherein the one or more processors are further configured to:
determine the first index based on an application a second ML model on the obtained first set of parameters;
determine the second index based on an application of the second ML model on the obtained second set of parameters; and
determine, based on the first index and the second index, the first accessibility score indicative of the accessibility of the usage of the set of vehicles in the first geographical region.

12. A method, comprising:
obtaining a first set of parameters associated with a consumption of a battery by a set of vehicles in a first geographical region;
obtaining a second set of parameters associated with at least one of the set of vehicles or a set of charging points within the first geographical region;
determining, based on the obtained first set of parameters, a first index indicative of the consumption of the battery by the set of vehicles in the first geographical region for a first time period;
determining, based on the obtained second set of parameters, a second index indicative of a utilization of at least one of the set of vehicles or the set of charging points within the first geographical region for the first time period;
determining, based on the first index and the second index, a first accessibility score indicative of an accessibility of a usage of the set of vehicles in the first geographical region for the first time period; and
outputting the determined first accessibility score for the first time period.

13. The method of claim 12, wherein the first set of parameters comprises at least one of vehicle parameters associated with each vehicle of the set of vehicles, or geographical region parameters associated with the first geographical region.

14. The method of claim 13, wherein the vehicle parameters are associated with at least one of a weight of each vehicle of the set of vehicles, a speed of each vehicle of the set of vehicles, a tire-size of each vehicle of the set of vehicles, an aerodynamic drag of each vehicle of the set of vehicles, an idling state of each vehicle of the set of vehicles, a battery size of each vehicle of the set of vehicles, a battery capacity of each vehicle of the set of vehicles or a battery consumption rate of each vehicle of the set of vehicles.

15. The method of claim 12, wherein the second set of parameters is associated with at least one of mobility patterns of a user of each vehicle of the set of vehicles, destination of each vehicle of the set of vehicles, a distance of each charging point of the set of charging points from each vehicle of the set of vehicles, an availability of each charging point of the set of charging points, or an infrastructure of the first geographical region.

16. The method of claim 12, further comprising:
receiving a first user input associated with a destination of a first vehicle of the set of vehicles, wherein the destination of the first vehicle is in the first geographical region;
determining, based on the first user input, the first accessibility score for the first geographical region;
determining a recommendation based on the first accessibility score; and
outputting the determined recommendation.

17. The method of claim 16, further comprising:
generating, based on the determined recommendation, one or more navigation instructions to navigate the first vehicle towards the destination; and
controlling, based on the one or more navigation instructions, the first vehicle to navigate towards the destination.

18. The method of claim 12, further comprising:
determining a consumption score based on a first correlation of the first index with a consumption factor;
determining a utilization score based on a second correlation of the second index with a utilization factor; and
determining the first accessibility score based on a third correlation of the consumption score with the utilization score.

19. The method of claim 12, further comprising:
generating a training dataset based on the obtained first set of parameters, the obtained second set of parameters, and the determined first accessibility score, and
training a first machine learning (ML) model based on the generated training dataset, wherein the first ML model is trained to determine an accessibility score for a geographical region.

20. A non-transitory computer-readable storage medium having computer programmable code instructions stored therein, the computer program code instructions, when executed by one or more processors, cause the one or more processors to:
obtain a first set of parameters associated with a consumption of a battery by a set of vehicles in a first geographical region;
obtain a second set of parameters associated with at least one of the set of vehicles or a set of charging points within the first geographical region;
determine, based on the obtained first set of parameters, a first index indicative of the consumption of the battery by the set of vehicles in the first geographical region;
determine, based on the obtained second set of parameters, a second index indicative of a utilization of at least one of the set of vehicles or the set of charging points within the first geographical region;
determine, based on the first index and the second index, a first accessibility score indicative of an accessibility of a usage of the set of vehicles in the first geographical region; and
output the determined first accessibility score.
